(19) United States
(12) Patent Application Publication
(10) Pub. No.: US 2026/0269730 A1
(43) Pub. Date: Sep. 10, 2026

(54) Multiphase Power Conversion System and Method

(71) Applicant: Reed Semiconductor Corporation, Warwick, RI (US)

(72) Inventors: Wenkai Wu, East Greenwich, RI (US); Weidong Zhu, East Lyme, CT (US); Cheng-Wei Chen, East Greenwhich, RI (US); Jialun Du, Powell, OH (US)

(21) Appl. No.: 19/661,447

(22) Filed: Apr. 28, 2026

Related U.S. Application Data
(63) Continuation-in-part of application No. 19/220,056, filed on May 27, 2025.
(60) Provisional application No. 63/653,210, filed on May 29, 2024.

(51) Int. Cl. H02M 3/158; H02M 1/00; H02M 3/157

(52) U.S. Cl. CPC H02M 3/1586; H02M 1/0009; H02M 3/157

(57) ABSTRACT

A power conversion system includes a multiphase controller comprising a PWM generator and a plurality of signal summing modules, wherein the PWM generator is configured to generate multiple groups of PWM signals, each group of PWM signals comprising a plurality of PWM signals, and each signal summing module is configured to receive each group of PWM signals respectively and combine the plurality of PWM signals in each group of PWM signals into a mixed PWM signal, and a plurality of power stage modules, each of the plurality of power stage modules comprising a phase splitter and a plurality of power stages, wherein the phase splitter is configured to receive the mixed PWM signal and split the mixed PWM signal into a plurality of phase-shifted PWM signals, and each of the plurality of power stages is configured to receive each of the plurality of phase-shifted PWM signals respectively.

### PRIORITY

This application is a continuation in part application of U.S. patent application Ser. No. 19/220,056, entitled “Multiphase Power Conversion System and Method” and filed on May 27, 2025, which claims the benefit of U.S. Provisional Application No. 63/653,210, filed on May 29, 2024, each of which is hereby incorporated herein by reference.

### TECHNICAL FIELD

The present disclosure relates generally to the field of integrated circuits, and in particular embodiments, to techniques and mechanisms for a multiphase power conversion system.

### BACKGROUND

As technologies further advance, a variety of processors such as Digital Signal Processors (DSPs), Field Programmable Gate Arrays (FPGAs), Central Processing Units (CPUs) and/or the like, have become popular. Each processor operates with a low supply voltage (e.g., sub-1V) and consumes a large amount of current. A multiphase power conversion system is employed to power the processor. The multiphase power conversion system comprises a multiphase controller and a plurality of power stages.

The multiphase controller is an integrated circuit designed to manage and regulate power delivery in systems requiring high efficiency and stability. This type of controller is commonly used in power supplies for processors consuming a large amount of current. The multiphase controller is configured to control a plurality of power stages by generating multiple Pulse Width Modulation (PWM) signals and monitoring current sense signals. The primary objective is to distribute the load across several phases, enhancing power delivery efficiency, reducing ripple, and improving overall performance.

The core of the multiphase controller is a PWM controller. In operation, the PWM controller generates precise PWM signals for each power stage. These signals are used to control the switching of MOSFETs in each phase, regulating the voltage and current supplied to the load. The PWM signals are typically phase-shifted to interleave the switching of each power stage. This reduces the input and output ripple currents, thereby improving the overall efficiency and reducing the size of filtering components.

Each phase includes a current sense amplifier to monitor the current flowing through the inductor of this phase. The current sense signals from the plurality of power stages provide feedback to the multiphase controller for load balancing and protection. By analyzing the current sense signals, the multiphase controller ensures that each phase shares the load evenly. This prevents any single phase from becoming overloaded and enhances the longevity and reliability of the power conversion system. The output voltage is compared to a reference voltage using an error amplifier. The error signal adjusts the duty cycle of the PWM signals to maintain a stable output voltage, compensating for load changes and input voltage variations. A closed-loop feedback system is used to continuously monitor and adjust the output voltage, ensuring precise regulation.

FIG. 1 illustrates a system configuration of a multiphase controller and a plurality of smart power stages. As shown in FIG. 1, the multiphase controller 100 is connected to the plurality of smart power stages 101, 102 and 103. The multiphase controller 100 feeds a PWM signal PWM1 to a first smart power stage 101. The multiphase controller 100 feeds a PWM signal PWM2 to a second smart power stage 102. The multiphase controller 100 feeds a PWM signal PWM3 to a third smart power stage 103. As shown in FIG. 1, the number of PWM signal paths is equal to the number of the smart power stages.

As shown in FIG. 1, the multiphase controller 100 receives a current sense signal CS1 from the first smart power stage 101. The multiphase controller 100 receives a current sense signal CS2 from the second smart power stage 102. The multiphase controller 100 receives a current sense signal CS3 from the third smart power stage 103. As shown in FIG. 1, the number of current sense signal paths is equal to the number of the smart power stages.

FIG. 1 shows that for a multiphase power conversion system having N smart power stages, the number of PWM signal paths is equal to N. The number of current sense signal paths is equal to N. In total, there are 2×N signal paths in FIG. 1.

FIG. 2 illustrates another system configuration of a multiphase controller and a plurality of smart power stages. The system configuration shown in FIG. 2 is similar to that shown in FIG. 1 except that two smart power stages (e.g., smart power stages 111 and 112, smart power stages 121 and 122, and smart power stages 131 and 132) are packaged in a dual smart power stage. In this system configuration, the multiphase controller 100 generates PWM signals fed into the smart power stages, and receives current sense signals sent from the smart power stages. As shown in FIG. 2, the number of PWM signal paths is equal to the number of the smart power stages. Likewise, the number of current sense signal paths is equal to the number of the smart power stages.

FIG. 2 shows for a multiphase power conversion system having N smart power stages, the number of PWM signal paths is equal to N. The number of current sense signal paths is equal to N. In total, there are 2×N signal paths in FIG. 2.

The multiphase controllers shown in FIGS. 1-2 act as the central control units that coordinate the operation of all smart power stages. Each multiphase controller generates PWM signals, which are essential for controlling the output voltage and current of each smart power stage. The PWM signals are precisely timed and modulated to manage power delivery efficiently. The multiphase controllers receive current sense signals from smart power stages. These current sense signals provide feedback about the current being delivered by each phase, allowing the multiphase controllers to monitor and adjust the operation of the smart power stages.

Each smart power stage represents an individual phase of the multiphase power conversion system. They are independently controlled by the PWM signals sent from the multiphase controller. Each smart power stage includes current sensing mechanisms to measure the current flowing through it. The sensed current data is then sent back to the multiphase controller. The current sense signals form a feedback loop that the multiphase controller uses to adjust the PWM signals dynamically, ensuring power delivery and load balancing across all phases.

In operation, the multiphase controller calculates the required PWM signals based on the desired output and the feedback received from the smart power stages. It sends out these PWM signals to each smart power stage, controlling their operation in a synchronized manner. Each smart power stage senses the current flowing through it and sends this data back to the multiphase controller. The multiphase controller processes this current sense information to determine the load distribution and current levels in each phase. Based on the feedback, the multiphase controller dynamically adjusts the PWM signals fed into each power stage. This adjustment helps in balancing the load, preventing any single phase from becoming overloaded, and maintaining the overall efficiency and stability of the multiphase power conversion system.

In a multiphase power conversion system, managing numerous signal paths efficiently is crucial to minimize layout issues and ensure better performance. It would be desirable to reduce the total number of signal paths. The present disclosure addresses this need.

### SUMMARY

Technical advantages are generally achieved, by embodiments of this disclosure which describe a multiphase power conversion system.

In accordance with an embodiment, a power conversion system comprises a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal, and a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage.

In accordance with another embodiment, a method comprises combining two PWM signals of a plurality of PWM signals into a mixed PWM signal fed into a dual power stage comprising a first power stage and a second power stage, splitting the mixed PWM signal into a first PWM signal fed into the first power stage and a second PWM signal fed into the second power stage, generating a first current sense signal and a second current sense signal, wherein the first current sense signal is proportional to a current flowing through a first inductor coupled to the first power stage and the second current sense signal is proportional to a current flowing through a second inductor coupled to the second power stage, and summing the first current sense signal and the second current sense signal together to obtain a mixed current sense signal fed into a PWM generator configured to generate the plurality of PWM signals.

In accordance with yet another embodiment, a system comprises a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal, a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage, a first inductor coupled between the first power stage and an output of the system, and a second inductor coupled between the second power stage and the output of the system.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a system configuration of a multiphase controller and a plurality of smart power stages;

FIG. 2 illustrates another system configuration of a multiphase controller and a plurality of smart power stages;

FIG. 3 illustrates a block diagram of a first implementation of a multiphase power conversion system having a reduced number of signal paths in accordance with various embodiments of the present disclosure;

FIG. 4 illustrates a block diagram of the multiphase controller shown in FIG. 3 in accordance with various embodiments of the present disclosure;

FIG. 5 illustrates a schematic diagram of the signal summing module shown in FIG. 4 in accordance with various embodiments of the present disclosure;

FIG. 6 illustrates a schematic diagram of the phase splitter shown in FIG. 3 in accordance with various embodiments of the present disclosure;

FIG. 7 illustrates various control signals associated with the phase splitter shown in FIG. 6 in accordance with various embodiments of the present disclosure;

FIG. 8 illustrates a schematic diagram of a first implementation of the dual power stage shown in FIG. 3 in accordance with various embodiments of the present disclosure;

FIG. 9 illustrates a schematic diagram of the first current sense apparatus shown in FIG. 8 in accordance with various embodiments of the present disclosure;

FIG. 10 illustrates a schematic diagram of the low side current sense unit shown in FIG. 9 in accordance with various embodiments of the present disclosure;

FIG. 11 illustrates a schematic diagram of the second current sense apparatus shown in FIG. 8 in accordance with various embodiments of the present disclosure;

FIG. 12 illustrates a schematic diagram of a second implementation of the dual power stage shown in FIG. 3 in accordance with various embodiments of the present disclosure;

FIG. 13 illustrates a block diagram of a second implementation of the multiphase power conversion system having a reduced number of signal paths in accordance with various embodiments of the present disclosure;

FIG. 14 illustrates a flow chart of a method for configuring the power conversion system shown in FIG. 3 in accordance with various embodiments of the present disclosure;

FIG. 15 illustrates a block diagram of a third implementation of a multiphase power conversion system having a reduced number of signal paths in accordance with various embodiments of the present disclosure;

FIG. 16 illustrates a block diagram of the multiphase controller shown in FIG. 15 in accordance with various embodiments of the present disclosure;

FIG. 17 illustrates a block diagram of a fourth implementation of a multiphase power conversion system having a reduced number of signal paths in accordance with various embodiments of the present disclosure;

FIG. 18 illustrates a block diagram of the multiphase controller shown in FIG. 17 in accordance with various embodiments of the present disclosure;

FIG. 19 illustrates a block diagram of a fifth implementation of a multiphase power conversion system having a reduced number of signal paths in accordance with various embodiments of the present disclosure;

FIG. 20 illustrates various control signals associated with the signal summing module shown in FIG. 18 operating in the first mode when the pulse width of PWM signals is less than 90 degrees in accordance with various embodiments of the present disclosure;

FIG. 21 illustrates various control signals associated with the phase splitter shown in FIG. 17 operating in the first mode when the pulse width of PWM signals is less than 90 degrees in accordance with various embodiments of the present disclosure;

FIG. 22 illustrates various control signals associated with the signal summing module shown in FIG. 18 operating in the second mode when the pulse width of PWM signals is equal to 90 degrees in accordance with various embodiments of the present disclosure;

FIG. 23 illustrates various control signals associated with the signal summing module shown in FIG. 18 operating in the second mode when the pulse width of PWM signals is greater than 90 degrees in accordance with various embodiments of the present disclosure;

FIG. 24 illustrates the 90-degree PWM signals generated by the 90-degree PWM generator in accordance with an embodiment of the power conversion system of the present disclosure;

FIG. 25 illustrates a schematic diagram of a first implementation of the signal summing module shown in FIG. 18 in accordance with various embodiments of the present disclosure;

FIG. 26 illustrates a schematic diagram of a second implementation of the signal summing module shown in FIG. 18 in accordance with various embodiments of the present disclosure;

FIG. 27 illustrates a schematic diagram of the phase splitter shown in FIG. 17 operating in the first mode when the pulse width of PWM signals is less than 90 degrees in accordance with various embodiments of the present disclosure;

FIG. 28 illustrates a schematic diagram of a first implementation of the quad power stage shown in FIG. 17 in accordance with various embodiments of the present disclosure;

FIG. 29 illustrates a block diagram of a sixth implementation of a multiphase power conversion system having a reduced number of signal paths in accordance with various embodiments of the present disclosure;

FIG. 30 illustrates waveforms of the PWM signals with a high duty cycle in accordance with various embodiments of the present disclosure; and

FIG. 31 illustrates a block diagram of a PWM processing unit in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a multiphase power conversion system. The disclosure may also be applied, however, to a variety of power conversion systems. Hereinafter, various embodiments will be explained in detail with reference to the accompanying drawings.

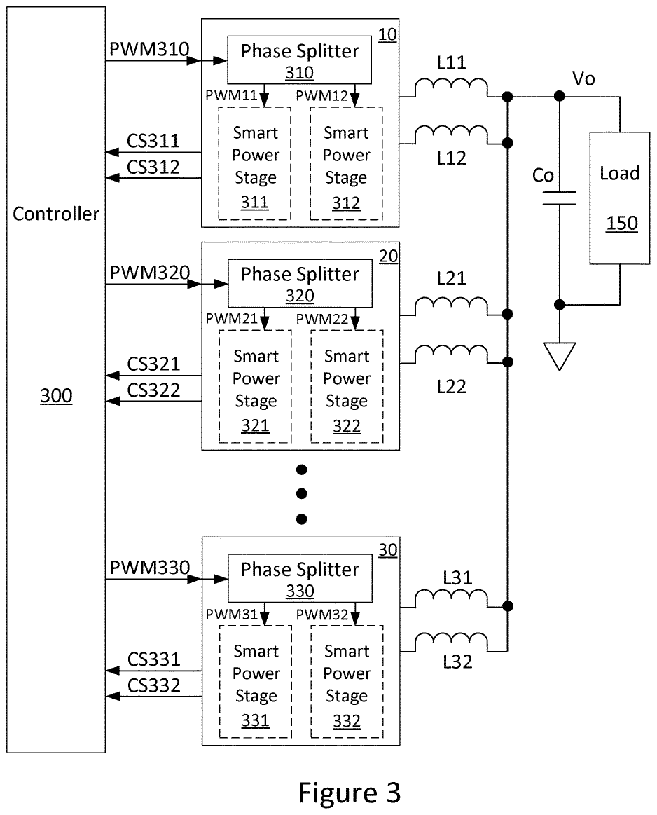

FIG. 3 illustrates a block diagram of a first implementation of a multiphase power conversion system having a reduced number of signal paths in accordance with various embodiments of the present disclosure. The multiphase power conversion system comprises a multiphase controller 300 and a plurality of dual smart power stages. Each dual smart power stage comprises two smart power stages. The smart power stage is implemented as a buck converter.

The multiphase controller 300 comprises a PWM generator and a plurality of signal summing modules. The PWM generator 305 is configured to generate a plurality of PWM signals. Each signal summing module is configured to receive two PWM signals and combine the two PWM signals into a mixed PWM signal (e.g., PWM310, PWM320 and PWM330).

As shown in FIG. 3, each dual smart power stage comprises a phase splitter and two smart power stages. A first dual smart power stage 10 comprises a first phase splitter 310 and smart power stages 311 and 312. The smart power stage 311 is alternatively referred to as a first power stage of the first dual smart power stage 10. The smart power stage 312 is alternatively referred to as a second power stage of the first dual smart power stage 10. The second dual smart power stage 20 comprises a second phase splitter 320 and smart power stages 321 and 322. The smart power stage 321 is alternatively referred to as a first power stage of the second dual smart power stage 20. The smart power stage 322 is alternatively referred to as a second power stage of the second dual smart power stage 20. The third dual smart power stage 30 comprises a third phase splitter 330 and smart power stages 331 and 332. The smart power stage 331 is alternatively referred to as a first power stage of the third dual smart power stage 30. The smart power stage 332 is alternatively referred to as a second power stage of the third dual smart power stage 30.

In operation, the first phase splitter 310 of the first dual smart power stage 10 is configured to receive the mixed PWM signal PWM310, and split the mixed PWM signal PWM310 into a first PWM signal PWM11 fed into the smart power stage 311 and a second PWM signal PWM12 fed into the smart power stage 312. The second phase splitter 320 of the second dual smart power stage 20 is configured to receive the mixed PWM signal PWM320, and split the mixed PWM signal PWM320 into a first PWM signal PWM21 fed into the smart power stage 321 and a second PWM signal PWM22 fed into the smart power stage 322. The third phase splitter 330 of the third dual smart power stage 30 is configured to receive the mixed PWM signal PWM330, and split the mixed PWM signal PWM330 into a first PWM signal PWM31 fed into the smart power stage 331 and a second PWM signal PWM32 fed into the smart power stage 332.

As shown in FIG. 3, the smart power stage 311 is configured to generate a first current sense signal CS311 of the first dual smart power stage 10 fed into the multiphase controller 300. The first current sense signal CS311 is proportional to a current flowing through an inductor L11 coupled to the smart power stage 311. The smart power stage 312 is configured to generate a second current sense signal CS312 of the first dual smart power stage 10 fed into the multiphase controller 300. The second current sense signal CS312 is proportional to a current flowing through an inductor L12 coupled to the smart power stage 312.

As shown in FIG. 3, the smart power stage 321 is configured to generate a first current sense signal CS321 of the second dual smart power stage 20 fed into the multiphase controller 300. The first current sense signal CS321 is proportional to a current flowing through an inductor L21 coupled to the smart power stage 321. The smart power stage 322 is configured to generate a second current sense signal CS322 of the second dual smart power stage 20 fed into the multiphase controller 300. The second current sense signal CS322 is proportional to a current flowing through an inductor L22 coupled to the smart power stage 322.

As shown in FIG. 3, the smart power stage 331 is configured to generate a first current sense signal CS331 of the third dual smart power stage 30 fed into the multiphase controller 300. The first current sense signal CS331 is proportional to a current flowing through an inductor L31 coupled to the smart power stage 331. The smart power stage 332 is configured to generate a second current sense signal CS332 of the third dual smart power stage 30 fed into the multiphase controller 300. The second current sense signal CS332 is proportional to a current flowing through an inductor L32 coupled to the smart power stage 332.

As shown in FIG. 3, the number of PWM signal paths between the multiphase controller 300 and the dual smart power stages is equal to the number of the dual smart power stages. The number of current sense signal paths between the multiphase controller 300 and the dual smart power stages is equal to the number of the smart power stages. FIG. 3 shows for a multiphase power conversion system having N smart power stages, the number of PWM signal paths is equal to N/2. The number of current sense signal paths is equal to N. In total, there are 1.5×N signal paths in FIG. 3.

One advantageous feature of the system configuration shown in FIG. 3 is that the total number of signal paths has been reduced from 2×N to 1.5×N. The reduced number of signal paths helps to minimize layout issues and ensures better performance.

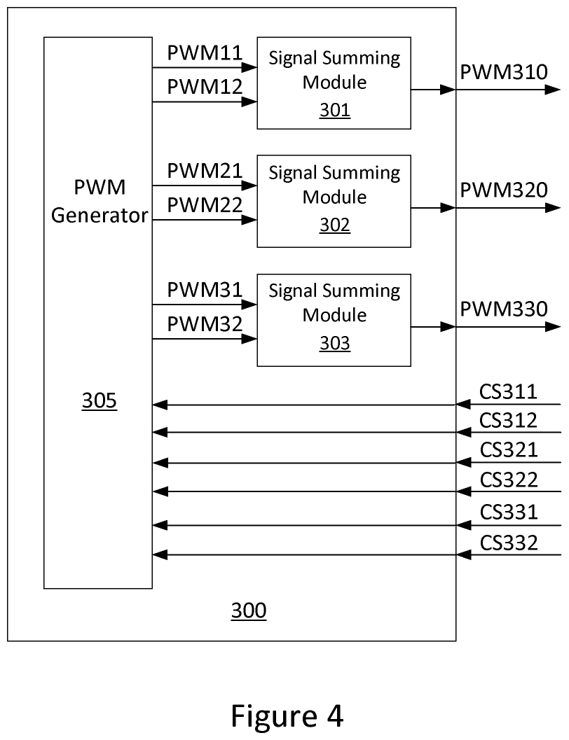

FIG. 4 illustrates a block diagram of the multiphase controller shown in FIG. 3 in accordance with various embodiments of the present disclosure. The multiphase controller 300 comprises a PWM generator 305 and a plurality of signal summing modules 301, 302 and 303. The PWM generator 305 is configured to generate a plurality of PWM signals. As shown in FIG. 4, each signal summing module is configured to receive two PWM signals and combine the two PWM signals into a mixed PWM signal. More particularly, a first signal summing module 301 receives PWM signals PWM11 and PWM12, and combines these two PWM signals into a mixed PWM signal PWM310 comprising PWM11 and PWM12. In some embodiments, a phase shift between PWM11 and PWM12 is equal to 180 degrees. Likewise, a second signal summing module 302 receives PWM signals PWM21 and PWM22, and combines these two PWM signals into a mixed PWM signal PWM320 comprising PWM21 and PWM22. In some embodiments, a phase shift between PWM21 and PWM22 is equal to 180 degrees. A third signal summing module 303 receives PWM signals PWM31 and PWM32, and combines these two PWM signals into a mixed PWM signal PWM330 comprising PWM31 and PWM32. In some embodiments, a phase shift between PWM31 and PWM32 is equal to 180 degrees.

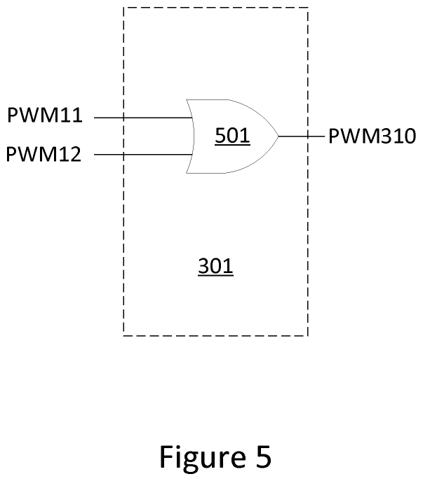

FIG. 5 illustrates a schematic diagram of the signal summing module shown in FIG. 4 in accordance with various embodiments of the present disclosure. The signal summing module 301 comprises an OR gate 501. As shown in FIG. 5, a first input of the OR gate 501 is configured to receive the PWM signal PWM11. A second input of the OR gate 501 is configured to receive the PWM signal PWM12. Because PWM11 and PWM12 are phase-shifted by 180 degrees, the OR gate 501 effectively combines them into a mixed PWM signal PWM310, in which PWM11 and PWM12 are interleaved with a 180-degree phase difference.

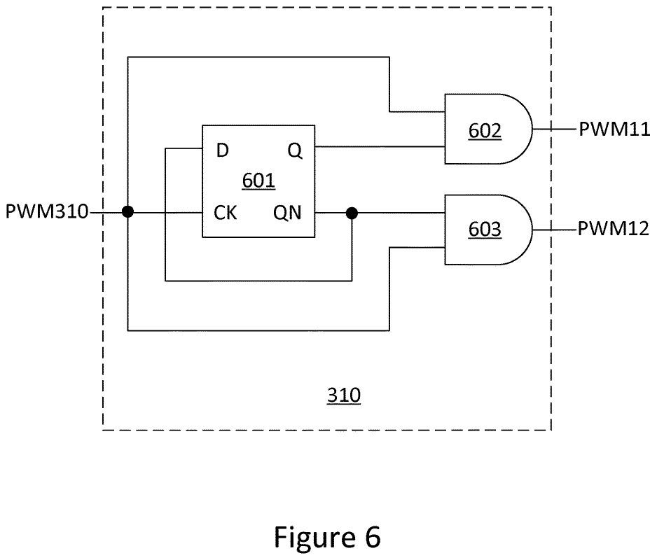

FIG. 6 illustrates a schematic diagram of the phase splitter shown in FIG. 3 in accordance with various embodiments of the present disclosure. The phase splitter 310 comprises a latch 601, a first AND gate 602 and a second AND gate 603. As shown in FIG. 6, a data input of the latch 601 is connected to an inverted output of the latch 601. A clock input of the latch 601 is configured to receive the mixed PWM signal PWM310. A first input of the first AND gate 602 is configured to receive the mixed PWM signal PWM310. A second input of the first AND gate 602 is connected to the output of the latch 601. An output of the first AND gate 602 is configured to generate the first PWM signal PWM11. A first input of the second AND gate 603 is connected to the inverted output of the latch 601. A second input of the second AND gate 603 is configured to receive the mixed PWM signal PWM310. An output of the second AND gate 603 is configured to generate the second PWM signal PWM12. In operation, the phase splitter 310 extracts the PWM signals PWM11 and PWM12 based upon the received mixed PWM signal PWM310.

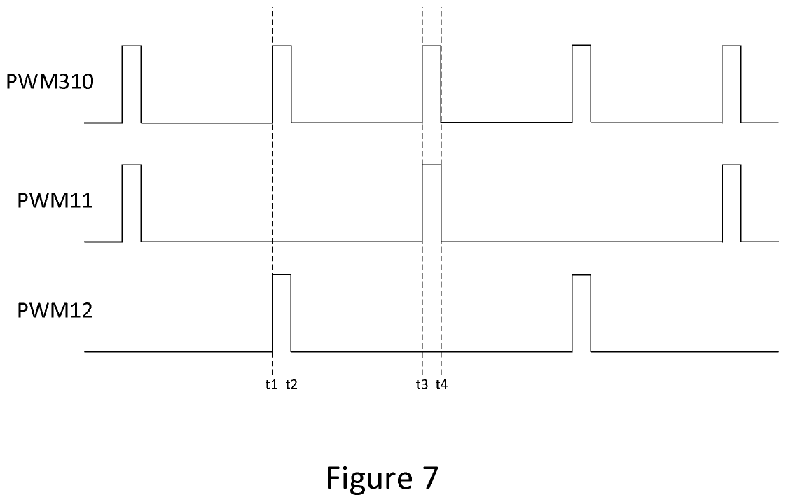

FIG. 7 illustrates various control signals associated with the phase splitter shown in FIG. 6 in accordance with various embodiments of the present disclosure. The horizontal axis of FIG. 7 represents intervals of time. There are three rows in FIG. 7. The first row represents the mixed PWM signal PWM310. The second row represents the first PWM signal PWM11. The third row represents the second PWM signal PWM12.

At t1, in response to the leading edge of the mixed PWM signal PWM310, the first PWM signal PWM11 remains the same. The second PWM signal PWM12 changes from a logic low state to a logic high state. At t2, in response to the falling edge of the mixed PWM signal PWM310, the first PWM signal PWM11 remains the same. The second PWM signal PWM12 changes from a logic high state to a logic low state.

At t3, in response to the leading edge of the mixed PWM signal PWM310, the second PWM signal PWM12 remains the same. The first PWM signal PWM11 changes from a logic low state to a logic high state. At t4, in response to the falling edge of the mixed PWM signal PWM310, the second PWM signal PWM12 remains the same. The first PWM signal PWM11 changes from a logic high state to a logic low state.

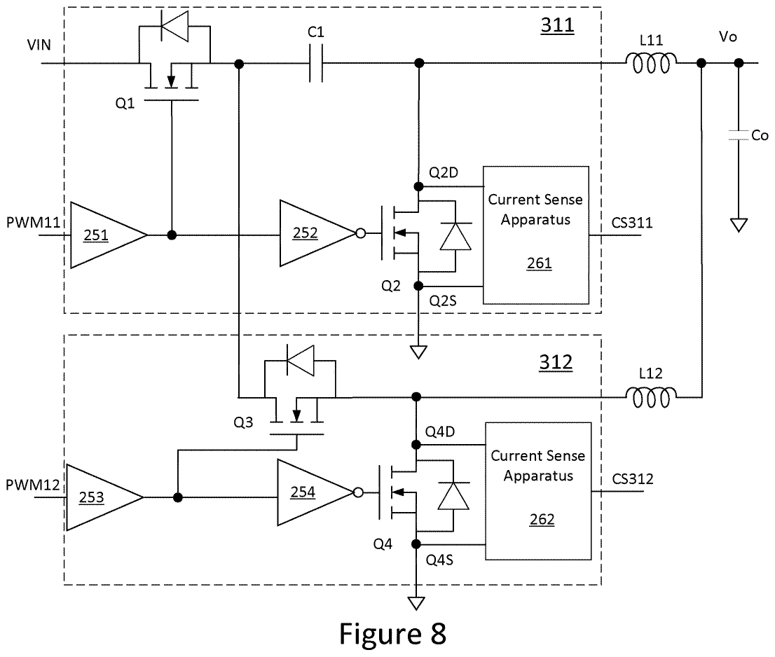

FIG. 8 illustrates a schematic diagram of a first implementation of the dual power stage shown in FIG. 3 in accordance with various embodiments of the present disclosure. The dual power stage comprises a first power stage 311 and a second power stage 312. As shown in FIG. 8, the first power stage 311 and the first inductor L11 form a first phase of the multiphase power conversion system. The second power stage 312 and the second inductor L12 form a second phase of the multiphase power conversion system. In operation, the first phase and the second phase are connected in parallel to supply power for a load coupled to the output voltage bus Vo of the multiphase power conversion system.

As shown in FIG. 8, the first phase of the multiphase power conversion system comprises a high-side switch Q1, a low-side switch Q2, a capacitor C1 and the first inductor L11. The high-side switch Q1 of the first phase, the capacitor C1 and the first inductor L11 are connected in series between an input voltage bus VIN and the output voltage bus Vo. The low-side switch Q2 of the first phase is connected between a common node of the capacitor C1 and the first inductor L11, and ground.

The second phase of the multiphase power conversion system comprises a high-side switch Q3, a low-side switch Q4 and the second inductor L12. The high-side switch Q3 of the second phase and the second inductor L12 are connected in series between a common node of the high-side switch Q1 of the first phase and the capacitor C1, and the output voltage bus Vo. The low-side switch Q4 of the second phase is connected between a common node of the high-side switch Q3 of the second phase and the second inductor L12, and ground. An output capacitor Co is connected between the output voltage bus Vo and ground. A load (not shown) is connected in parallel with the output capacitor Co.

In accordance with an embodiment, the switches (e.g., switches Q1-Q4) may be metal oxide semiconductor field-effect transistor (MOSFET) devices. Alternatively, the switches can be any controllable switches such as insulated gate bipolar transistor (IGBT) devices, integrated gate commutated thyristor (IGCT) devices, gate turn-off thyristor (GTO) devices, silicon-controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted while FIG. 8 shows that the switches Q1 and Q3 are implemented as single n-type transistors, a person skilled in the art would recognize there may be many variations, modifications and alternatives. For example, depending on different applications and design needs, the switches Q1 and Q3 may be implemented as p-type transistors. Furthermore, each switch shown in FIG. 8 may be implemented as a plurality of switches connected in parallel.

The multiphase power conversion system further comprises a first high-side driver 251, a second high-side driver 253, a first inverter 252 and a second inverter 254. In some embodiments, the first inverter 252 functions as a first low-side driver. The second inverter 254 functions as a second low-side driver.

The first high-side driver 251 is configured to receive the first PWM signal PWM11. Based on the received signal, the first high-side driver 251 generates a high-side gate drive signal applied to the gate of the high-side switch Q1. Furthermore, the first PWM signal PWM11 passes through the first inverter 252. Based on the received signal, the first inverter 252 generates a low-side gate drive signal applied to the gate of the low-side switch Q2.

The second high-side driver 253 is configured to receive the second PWM signal PWM12. Based on the received signal, the second high-side driver 253 generates a high-side gate drive signal applied to the gate of the high-side switch Q3. Furthermore, the second PWM signal PWM12 passes through the second inverter 254. Based on the received signal, the second inverter 254 generates a low-side gate drive signal applied to the gate of the low-side switch Q4.

The driver circuit shown in FIG. 8 is a simplified representation provided to illustrate the innovative aspects of the present disclosure. It should be understood that in practical implementations, the driver circuit may include additional functional blocks such as a dead time control circuit or other necessary circuitry to ensure proper operation.

The multiphase power conversion system further comprises a first current sense apparatus 261 and a second current sense apparatus 262. As shown in FIG. 8, a first input of the first current sense apparatus 261 is connected to a drain Q2D of the low-side switch Q2. A second input of the first current sense apparatus 261 is connected to a source Q2S of the low-side switch Q2. The first current sense apparatus 261 is configured to sense the current flowing through the first inductor L11. As shown in FIG. 8, the first current sense apparatus 261 is configured to generate a first current sense signal CS311.

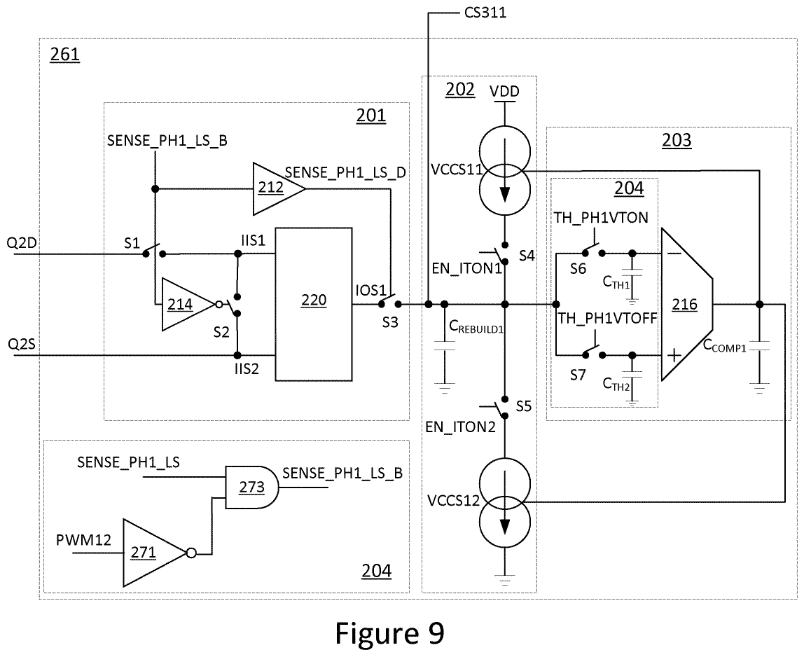

In some embodiments, the first current sense apparatus 261 comprises a first phase PWM off time current sense circuit, a first phase PWM on and off time current rebuild circuit and a first phase feedback loop. The detailed structure and operating principle of the first current sense apparatus 261 will be described below with respect to FIG. 9.

As shown in FIG. 8, a first input of the second current sense apparatus 262 is connected to a drain Q4D of the low-side switch Q4. A second input of the second current sense apparatus 262 is connected to a source Q4S of the low-side switch Q4. The second current sense apparatus 262 is configured to sense the current flowing through the second inductor L12. As shown in FIG. 8, the second current sense apparatus 262 is configured to generate a second current sense signal CS312.

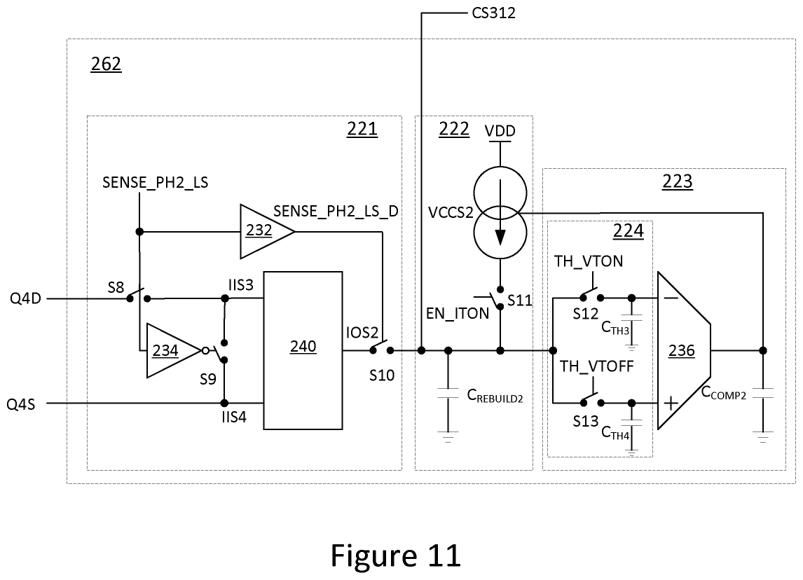

In some embodiments, the second current sense apparatus 262 comprises a second phase PWM off time current sense circuit, a second phase PWM on time current rebuild circuit and a second phase feedback loop. The detailed structure and operating principle of the second current sense apparatus 262 will be described below with respect to FIG. 11.

In operation, the first phase PWM off time current sense circuit is configured to generate a first portion and a third portion of a first phase PWM off time current signal proportional to the current flowing through the first inductor L11 when the high-side switch Q1 is turned off, the high-side switch Q3 is turned off, and the low-side switch Q2 is turned on.

In operation, the first phase PWM on and off time current rebuild circuit is configured to construct a second portion of the first phase PWM off time current signal using a second voltage-controlled current source to discharge a first rebuild capacitor when the high-side switch Q3 of the second phase is turned on. Furthermore, the first phase PWM on and off time current rebuild circuit is configured to construct an artificial first phase inductor current signal using a first voltage-controlled current source to charge the first rebuild capacitor when a high-side switch Q1 of the first phase is turned on.

In operation, the first phase feedback loop is configured to adjust the current flowing through the second voltage-controlled current source so as to force a saved voltage of the second portion of the first phase PWM off time current signal to be equal to a saved voltage of the third portion of the first phase PWM off time current signal. Furthermore, the first phase feedback loop is configured to adjust a current flowing through the first voltage-controlled current source so as to force a saved voltage of the artificial first phase inductor current signal to be equal to a saved voltage of the first portion of the first phase PWM off time current signal.

In operation, the second phase PWM off time current sense circuit is configured to generate a second phase PWM off time current signal proportional to a current flowing through the second inductor L12 when the high-side switch Q3 of the second phase is turned off and the low-side switch Q4 of the second phase is turned on.

In operation, the second phase PWM on time current rebuild circuit is configured to construct an artificial second phase inductor current signal using a second phase voltage-controlled current source to charge a second rebuild capacitor when the high-side switch Q3 of the second phase is turned on.

In operation, the second phase feedback loop is configured to adjust a current flowing through the second phase voltage-controlled current source so as to force a saved voltage of the artificial second phase inductor current signal to be equal to a saved voltage of the second phase PWM off time current signal.

FIG. 9 illustrates a schematic diagram of the first current sense apparatus shown in FIG. 8 in accordance with various embodiments of the present disclosure. The first current sense apparatus 261 comprises a first phase PWM off time current sense circuit 201, a first phase PWM on and off time current rebuild circuit 202, a first phase feedback loop 203 and a blanking circuit 204 as shown in FIG. 9.

The blanking circuit 204 comprises an AND gate 273 and a blanking inverter 271. The input of the blanking inverter 271 is configured to receive PWM12. The first input of the AND gate 273 is configured to receive a low-side current sense control signal SENSE_PH1_LS. The second input of the AND gate 273 is coupled to the output of the blanking inverter 271. The output of the AND gate 273 is configured to generate a blanked low-side current sense control signal SENSE_PH1_LS_B.

The first phase PWM off time current sense circuit 201 comprises a low-side switch current sense unit 220, a first switch S1, a second switch S2, a third switch S3, an inverter 214 and a delay unit 212. As shown in FIG. 9, the low-side switch current sense unit 220 has a first input IIS1 coupled to Q2D through the first switch S1, a second input IIS2 connected to ground, and an output IOS1 configured to generate a first phase PWM off time current signal.

As shown in FIG. 9, the third switch S3 is connected to the output of the low-side switch current sense unit 220. The blanked low-side current sense control signal SENSE_PH1_LS_B is configured to control the first switch S1 directly, and control the second switch S2 through the inverter 214. The blanked low-side current sense control signal SENSE_PH1_LS_B is also configured to control the third switch S3 through the delay unit 212. The delay unit 212 is configured to add a predetermined delay into the blanked low-side current sense control signal SENSE_PH1_LS_B. The delay unit 212 generates a delayed rising edge signal SENSE_PH1_LS_D. In other words, there is a predetermined delay between the rising edge of SENSE_PH1_LS_B and the rising edge of SENSE_PH1_LS_D. As shown in FIG. 9, the first phase PWM off time current signal generated by the low-side switch current sense unit 220 is fed into a first rebuild capacitor C_{REBUILD1} through the third switch S3.

In operation, the first phase PWM off time current sense circuit 201 is configured to generate the first phase PWM off time current signal, which is proportional to a current flowing through the first inductor L11 when the high-side switch Q1 of the first phase is turned off, the high-side switch Q3 of the second phase is turned off, and the low-side switch Q2 of the first phase is turned on.

The first phase PWM on and off time current rebuild circuit 202 comprises a first voltage-controlled current source VCCS11, a second voltage-controlled current source VCCS12, the first rebuild capacitor C_{REBUILD1}, a fourth switch S4 and a fifth switch S5. As shown in FIG. 9, the first voltage-controlled current source VCCS11, the fourth switch S4, the fifth switch S5 and the second voltage-controlled current source VCCS12 are connected in series between a bias voltage source VDD and ground. The first rebuild capacitor C_{REBUILD1} is connected between a common node of S4 and S5, and ground. The fourth switch S4 is controlled by a first enable signal EN_ITON1. The first enable signal EN_ITON1 is configured such that the fourth switch S4 is turned on when the high-side switch Q1 is turned on. The fifth switch S5 is controlled by a second enable signal EN_ITON2. The second enable signal EN_ITON2 is configured such that the fifth switch S5 is turned on when the high-side switch Q3 is turned on.

In operation, the first phase PWM on and off time current rebuild circuit 202 is configured to construct an artificial inductor current signal using the first voltage-controlled current source VCCS11 to charge the first rebuild capacitor C_{REBUILD1} when the high-side switch Q1 of the first phase is turned on. Furthermore, the first phase PWM on and off time current rebuild circuit 202 is configured to construct the second portion of the first phase PWM off time current signal using the second voltage-controlled current source VCCS12 to discharge the first rebuild capacitor C_{REBUILD1} when the high-side switch Q3 of the second phase is turned on.

The first phase feedback loop 203 comprises a track-and-hold circuit 204, a transconductance amplifier 216 and a first compensation capacitor C_{COMP1}. An input of the track-and-hold circuit 204 is connected to both the first phase PWM off time current sense circuit 201 and the first phase PWM on and off time current rebuild circuit 202. Two inputs of the transconductance amplifier 216 are connected to two outputs of the track-and-hold circuit 204, respectively. The first compensation capacitor C_{COMP1} is connected to an output of the transconductance amplifier 216.

As shown in FIG. 9, the track-and-hold circuit 204 comprises a sixth switch S6, a first hold capacitor C_{TH1}, a seventh switch S7 and a second hold capacitor C_{TH2}. The sixth switch S6 and the first hold capacitor C_{TH1} are connected in series between the input of the track-and-hold circuit 204 and ground. A common node of the sixth switch S6 and the first hold capacitor C_{TH1} is connected to a first input of the transconductance amplifier 216. The seventh switch S7 and the second hold capacitor C_{TH2} are connected in series between the input of the track-and-hold circuit 204 and ground. A common node of the seventh switch S7 and the second hold capacitor C_{TH2} is connected to a second input of the transconductance amplifier 216.

The first phase feedback loop 203 is capable of constructing the current sense signal through adjusting the current generated by the first voltage-controlled current source VCCS11.

In operation, the sixth switch S6 is controlled by a first control signal TH_PH1VTON. The first control signal TH_PH1VTON is configured such that a saved voltage of the artificial first phase inductor current signal is held on the first hold capacitor C_{TH1}. The saved voltage of the artificial first phase inductor current signal is approximately equal to the voltage of the current sense signal at the time instant at which Q1 is turned off. The seventh switch S7 is controlled by a second control signal TH_PH1VTOFF. The second control signal TH_PH1VTOFF is configured such that a saved voltage of the first portion of the first phase PWM off time current signal is held on the second hold capacitor C_{TH2}. The saved voltage of the first portion of the first phase PWM off time current signal is approximately equal to the voltage of the first portion of the first phase PWM off time current signal at the time instant at which Q2 is turned on.

In operation, the first phase feedback loop 203 is configured to adjust a current flowing through the first voltage-controlled current source VCCS11 so as to make the saved voltage of the artificial first phase inductor current signal equal to the saved voltage of the first portion of the first phase PWM off time current signal. Once the saved voltage of the artificial first phase inductor current signal is equal to the saved voltage of the first portion of the first phase PWM off time current signal, the artificial first phase inductor current signal is of a shape similar to that of the current flowing through the high-side switch Q1.

The first phase feedback loop 203 is also capable of constructing the waveform of the current sense signal in the time period in which Q3 is turned on through adjusting the current generated by the second voltage-controlled current source VCCS12.

In operation, the second control signal TH_PH1VTOFF is configured such that a saved voltage of the second portion of the first phase PWM off time current signal is held on the second hold capacitor C_{TH2}. The saved voltage of the second portion of the first phase PWM off time current signal is approximately equal to the voltage of the current sense signal at a time instant at which Q3 is turned off and Q4 is turned on. The first control signal TH_PH1VTON is configured such that a saved voltage of the third portion of the first phase PWM off time current signal is held on the first hold capacitor C_{TH1}. The saved voltage of the third portion of the first phase PWM off time current signal is approximately equal to the voltage of the third portion of the first phase PWM off time current signal at a time instant at which Q3 is turned off and Q4 is turned on.

In operation, the first phase feedback loop 203 is configured to adjust a current flowing through the second voltage-controlled current source VCCS12 so as to make the saved voltage of the second portion of the first phase PWM off time current signal equal to the saved voltage of the third portion of the first phase PWM off time current signal. Once the saved voltage of the second portion of the first phase PWM off time current signal is equal to the saved voltage of the third portion of the first phase PWM off time current signal, the second portion of the first phase PWM off time current signal has a shape similar to the current flowing through the first inductor L11.

It should be noted that the single-ended current sense apparatus shown in FIG. 9 can be designed in a fully-differential form. More particularly, the low-side switch current sense unit 220 can be implemented as a fully-differential amplifier. The two outputs of the fully-differential amplifier are fed into two rebuild capacitors, two voltage-controlled current sources, two track-and-hold circuits and two transconductance amplifiers. In other words, there are two closely related symmetrical PWM on time current rebuild circuits in a current sense apparatus designed in a fully-differential form.

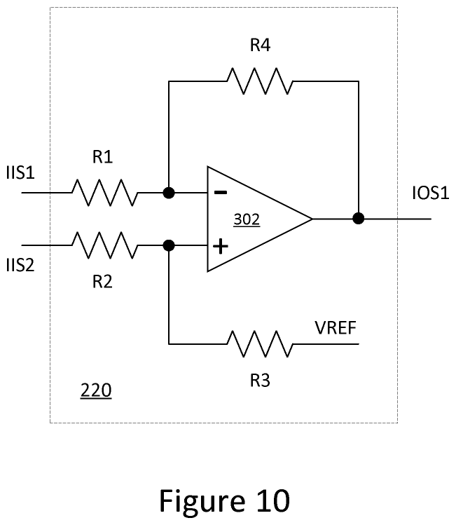

FIG. 10 illustrates a schematic diagram of the low side current sense unit shown in FIG. 9 in accordance with various embodiments of the present disclosure. In some embodiments, the low-side switch current sense unit 220 is implemented as a differential to single-ended amplifier. As shown in FIG. 10, the differential to single-ended amplifier comprises an amplifier 302, a first resistor R1, a second resistor R2, a third resistor R3 and a fourth resistor R4.

The first resistor R1 is connected between the first input IIS1 and an inverting input of the amplifier 302. The second resistor R2 is connected between the second input IIS2 and a non-inverting input of the amplifier 302. The third resistor R3 is connected between the non-inverting input of the amplifier 302 and a predetermined reference VREF. The fourth resistor R4 is connected between the inverting input of the amplifier 302 and the output IOS1 of the amplifier 302.

FIG. 11 illustrates a schematic diagram of the second current sense apparatus shown in FIG. 8 in accordance with various embodiments of the present disclosure. The second current sense apparatus 262 comprises a second phase PWM off time current sense circuit 221, a second phase PWM on time current rebuild circuit 222 and a second phase feedback loop 223 as shown in FIG. 11.

The second phase PWM off time current sense circuit 221 comprises a low-side switch current sense unit 240, an eighth switch S8, a ninth switch S9, a tenth switch S10, an inverter 234 and a delay unit 232. The low-side current sense control signal SENSE_PH2_LS is configured to control the eighth switch S8 directly, and control the ninth switch S9 through the inverter 234. The low-side current sense control signal SENSE_PH2_LS is also configured to control the tenth switch S10 through the delay unit 232. The operating principle of the second phase PWM off time current sense circuit 221 is similar to that of the first phase PWM off time current sense circuit 201 shown in FIG. 9, and hence is not discussed herein to avoid repetition.

The second phase PWM on time current rebuild circuit 222 comprises a second phase voltage-controlled current source VCCS2, a second rebuild capacitor C_{REBUILD2} and an eleventh switch S11. As shown in FIG. 11, the second phase voltage-controlled current source VCCS2, the eleventh switch S11 and the second rebuild capacitor C_{REBUILD2} are connected in series between the bias voltage source VDD and ground. The eleventh switch S11 is controlled by an enable signal EN_ITON. The operating principle of the second phase PWM on time current rebuild circuit 222 is similar to that of the first phase PWM on and off time current rebuild circuit 202 shown in FIG. 9, and hence is not discussed herein to avoid repetition.

The second phase feedback loop 223 comprises a track-and-hold circuit 224, a transconductance amplifier 236 and a second compensation capacitor C_{COMP2}. The track-and-hold circuit 224 comprises a twelfth switch S12, a third hold capacitor C_{TH3}, a thirteenth switch S13 and a fourth hold capacitor C_{TH4}. The operating principle of the second phase feedback loop 223 is similar to that of the first phase feedback loop 203 shown in FIG. 9, and hence is not discussed herein to avoid repetition.

In some embodiments, the second phase PWM off time current sense circuit 221, the second phase PWM on time current rebuild circuit 222 and the second phase feedback loop 223 are configured to generate a second current sense signal CS312. The second current sense signal CS312 includes two portions. A first portion is formed by sensing a current flowing through the low-side switch Q4 when the low-side switch Q4 is turned on. A second portion is generated based on the artificial second phase inductor current signal when the high-side switch Q3 is turned on.

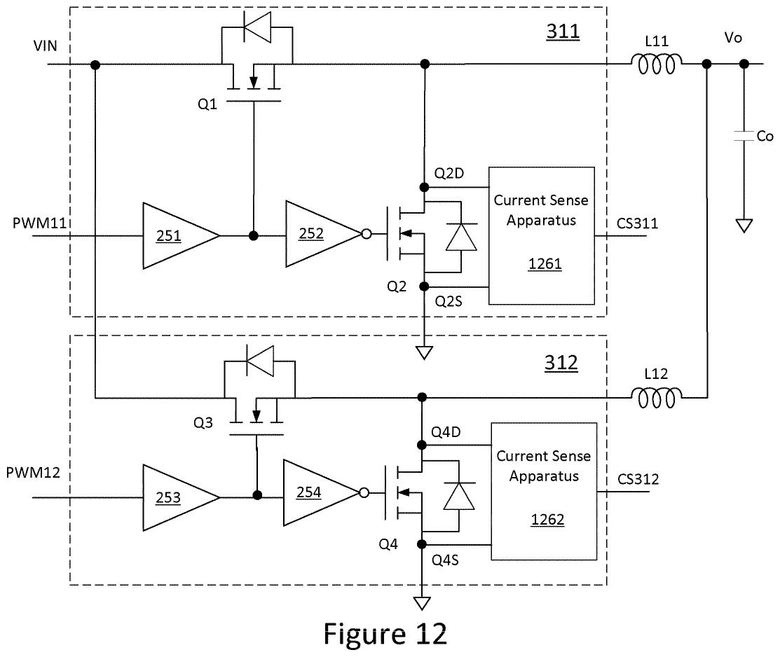

FIG. 12 illustrates a schematic diagram of a second implementation of the dual power stage shown in FIG. 3 in accordance with various embodiments of the present disclosure. The dual power stage comprises a first power stage 311 and a second power stage 312. As shown in FIG. 12, the first power stage 311 and the first inductor L11 form a first phase of the multiphase power conversion system. The second power stage 312 and the second inductor L12 form a second phase of the multiphase power conversion system. In operation, the first phase and the second phase are connected in parallel to supply power for a load coupled to the output voltage bus Vo of the multiphase power conversion system.

As shown in FIG. 12, the first phase of the multiphase power conversion system comprises a high-side switch Q1, a low-side switch Q2 and a first inductor L11. The high-side switch Q1 of the first phase and the first inductor L11 are connected in series between an input voltage bus VIN and the output voltage bus Vo. The low-side switch Q2 of the first phase is connected between a common node of the high-side switch Q1 of the first phase and the first inductor L11, and ground.

The second phase of the multiphase power conversion system comprises a high-side switch Q3, a low-side switch Q4 and the second inductor L12. The high-side switch Q3 of the second phase and the second inductor L12 are connected in series between the input voltage bus VIN and the output voltage bus Vo. The low-side switch Q4 of the second phase is connected between a common node of the high-side switch Q3 of the second phase and the second inductor L12, and ground. An output capacitor Co is connected between the output voltage bus Vo and ground.

The multiphase power conversion system further comprises a first current sense apparatus 1261 and a second current sense apparatus 1262. As shown in FIG. 12, a first input of the first current sense apparatus 1261 is connected to a drain Q2D of the low-side switch Q2. A second input of the first current sense apparatus 1261 is connected to a source Q2S of the low-side switch Q2. The first current sense apparatus 1261 is configured to sense the current flowing through the first inductor L11. As shown in FIG. 12, the first current sense apparatus 1261 is configured to generate a first current sense signal CS311. The structure and operating principle of the first current sense apparatus 1261 are similar to the structure and operating principle of the current sense apparatus 262 shown in FIG. 8, and hence are not discussed herein to avoid repetition.

As shown in FIG. 12, a first input of the second current sense apparatus 1262 is connected to a drain Q4D of the low-side switch Q4. A second input of the second current sense apparatus 1262 is connected to a source Q4S of the low-side switch Q4. The second current sense apparatus 1262 is configured to sense the current flowing through the second inductor L12. As shown in FIG. 12, the second current sense apparatus 1262 is configured to generate a second current sense signal CS312. The structure and operating principle of the second current sense apparatus 1262 are similar to the structure and operating principle of the current sense apparatus 262 shown in FIG. 8, and hence are not discussed herein to avoid repetition.

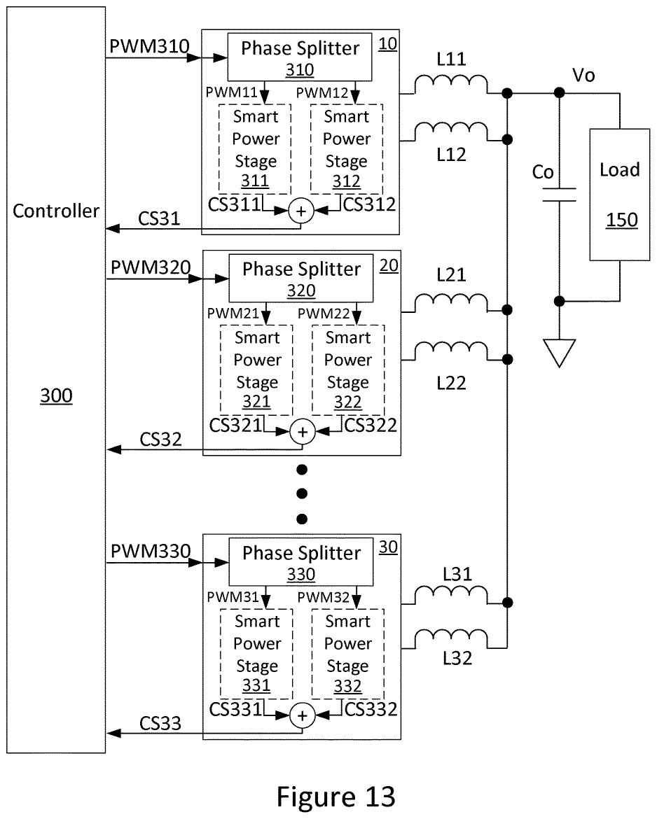

FIG. 13 illustrates a block diagram of a second implementation of the multiphase power conversion system having a reduced number of signal paths in accordance with various embodiments of the present disclosure. The system configuration shown in FIG. 13 is similar to that shown in FIG. 3 except that each of the plurality of dual smart power stages comprises a current summing module.

As shown in FIG. 13, the smart power stage 311 is configured to generate a first current sense signal CS311 fed into a first input of a current summing module of the first dual smart power stage 10. The smart power stage 312 is configured to generate a second current sense signal CS312 fed into a second input of the current summing module of the first dual smart power stage 10. The current summing module is configured to sum the first current sense signal CS311 and the second current sense signal CS312 together to obtain a mixed current sense signal CS31 fed into the multiphase controller 300.

As shown in FIG. 13, the smart power stage 321 is configured to generate a third current sense signal CS321 fed into a first input of the current summing module of the second dual smart power stage 20. The smart power stage 322 is configured to generate a fourth current sense signal CS322 fed into a second input of the current summing module of the second dual smart power stage 20. The current summing module is configured to sum the third current sense signal CS321 and the fourth current sense signal CS322 together to obtain a mixed current sense signal CS32 fed into the multiphase controller 300.

As shown in FIG. 13, the smart power stage 331 is configured to generate a fifth current sense signal CS331 fed into a first input of the current summing module of the third dual smart power stage 30. The smart power stage 332 is configured to generate a sixth current sense signal CS332 fed into a second input of the current summing module of the third dual smart power stage 30. The current summing module is configured to sum the fifth current sense signal CS331 and the sixth current sense signal CS332 together to obtain a mixed current sense signal CS33 fed into the multiphase controller 300.

As shown in FIG. 13, the number of PWM signal paths between the multiphase controller 300 and the dual smart power stages is equal to a number of the dual smart power stages. The number of current sense signal paths between the multiphase controller 300 and the dual smart power stages is equal to the number of the dual smart power stages. FIG. 13 shows for a multiphase power conversion system having N smart power stages, the number of PWM signal paths is equal to N/2. The number of current sense signal paths is equal to N/2. In total, there are 1×N signal paths in FIG. 13.

One advantageous feature of the system configuration shown in FIG. 13 is that the total number of signal paths has been reduced (from 2×N to 1×N). The reduced number of signal paths helps to minimize layout issues and ensures better performance.

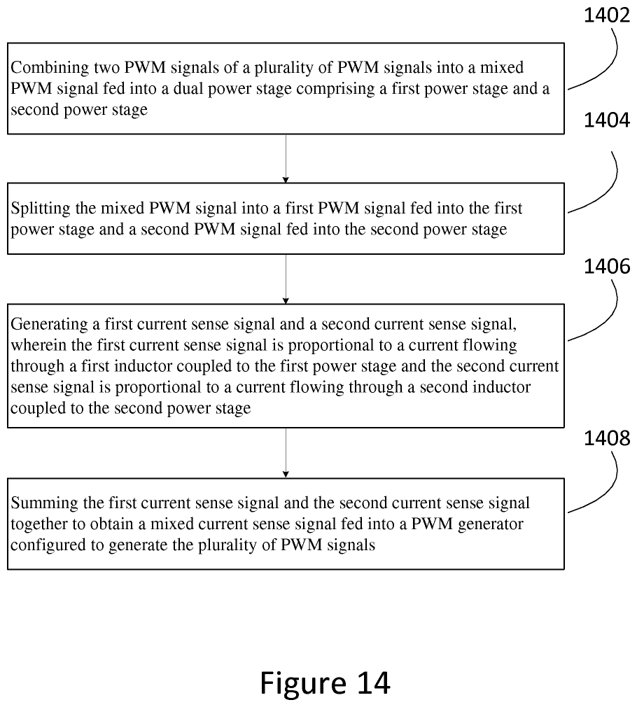

FIG. 14 illustrates a flow chart of a method for configuring the power conversion system shown in FIG. 3 in accordance with various embodiments of the present disclosure. This flowchart shown in FIG. 14 is merely an example, which should not unduly limit the scope of the claims. One of ordinary skill in the art would recognize many variations, alternatives, and modifications. For example, various steps illustrated in FIG. 14 may be added, removed, replaced, rearranged and repeated.

At step 1402, two PWM signals of a plurality of PWM signals are combined into a mixed PWM signal fed into a dual power stage comprising a first power stage and a second power stage.

At step 1404, the mixed PWM signal is split into a first PWM signal fed into the first power stage and a second PWM signal fed into the second power stage.

At step 1406, a first current sense signal and a second current sense signal are generated, wherein the first current sense signal is proportional to a current flowing through a first inductor coupled to the first power stage and the second current sense signal is proportional to a current flowing through a second inductor coupled to the second power stage.

At step 1408, the first current sense signal and the second current sense signal are summed together to obtain a mixed current sense signal fed into a PWM generator configured to generate the plurality of PWM signals.

In some embodiments, the first power stage comprises a high-side switch and a low-side switch connected in series between an input voltage bus and ground, and wherein the first inductor is connected to a common node of the high-side switch and the low-side switch, and a current sense apparatus having two inputs coupled to two terminals of the low-side switch, respectively, and an output configured to generate the first current sense signal.

The method further comprises generating, by a PWM off time current sense circuit, a PWM off time current signal proportional to a current flowing through the first inductor when the high-side switch is turned off and the low-side switch is turned on, constructing, by a PWM on time current rebuild circuit, an artificial inductor current signal using a voltage-controlled current source to charge a rebuild capacitor when the high-side switch is turned on, and adjusting, by a feedback loop, a current flowing through the voltage-controlled current source so as to force a saved voltage of the artificial inductor current signal to be equal to a saved voltage of the PWM off time current signal.

The method further comprises upon detecting that the saved voltage of the artificial inductor current signal is higher than the saved voltage of the PWM off time current signal, adjusting the voltage-controlled current source to decrease the saved voltage of the artificial inductor current signal until the saved voltage of the artificial inductor current signal is equal to the saved voltage of the PWM off time current signal, and upon detecting that the saved voltage of the artificial inductor current signal is lower than the saved voltage of the PWM off time current signal, adjusting the voltage-controlled current source to increase the saved voltage of the artificial inductor current signal until the saved voltage of the artificial inductor current signal is equal to the saved voltage of the PWM off time current signal.

In some embodiments, the PWM off time current sense circuit comprises a low-side switch current sense unit, a first switch, a second switch, a third switch, an inverter, a delay unit, and wherein the low-side switch current sense unit has a first input coupled to the common node of the high-side switch and the low-side switch, a second input connected to ground, and an output configured to generate the PWM off time current signal, the first switch is connected between the common node of the high-side switch and the low-side switch, and the first input of the low-side switch current sense unit, the second switch is connected between the first input and the second input of the low-side switch current sense unit, the third switch is connected to the output of the low-side switch current sense unit, wherein the PWM off time current signal is fed into the rebuild capacitor through the third switch, a low-side current sense control signal is configured to control the first switch directly and control the second switch through the inverter, and the low-side current sense control signal is configured to control the third switch through the delay unit. The PWM on time current rebuild circuit comprises the voltage-controlled current source, the rebuild capacitor and a fourth switch, and wherein the voltage-controlled current source is connected to the rebuild capacitor through the fourth switch, and the fourth switch is controlled by an enable signal, and wherein the fourth switch is configured to be turned on when the high-side switch is turned on. The feedback loop comprises a track-and-hold circuit, a transconductance amplifier and a compensation capacitor, and wherein an input of the track-and-hold circuit is connected to both the PWM off time current sense circuit and the PWM on time current rebuild circuit, two inputs of the transconductance amplifier are connected to two outputs of the track-and-hold circuit, respectively, and the compensation capacitor is connected to an output of the transconductance amplifier, and wherein the track-and-hold circuit comprises a fifth switch, a first hold capacitor, a sixth switch and a second hold capacitor, and wherein the fifth switch and the first hold capacitor are connected in series between the input of the track-and-hold circuit and ground, and wherein a common node of the fifth switch and the first hold capacitor is connected to a first input of the transconductance amplifier, and the sixth switch and the second hold capacitor are connected in series between the input of the track-and-hold circuit and ground, and wherein a common node of the sixth switch and the second hold capacitor is connected to a second input of the transconductance amplifier.

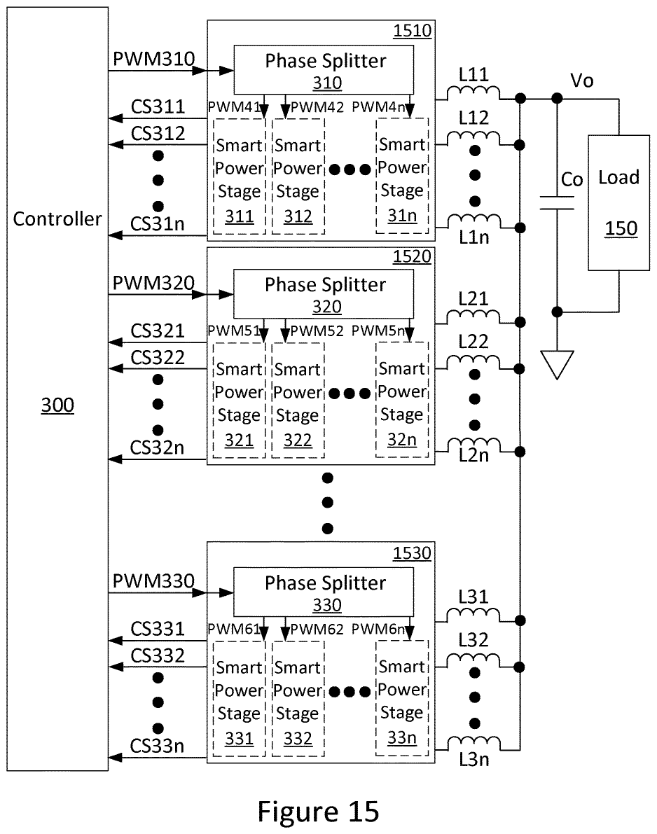

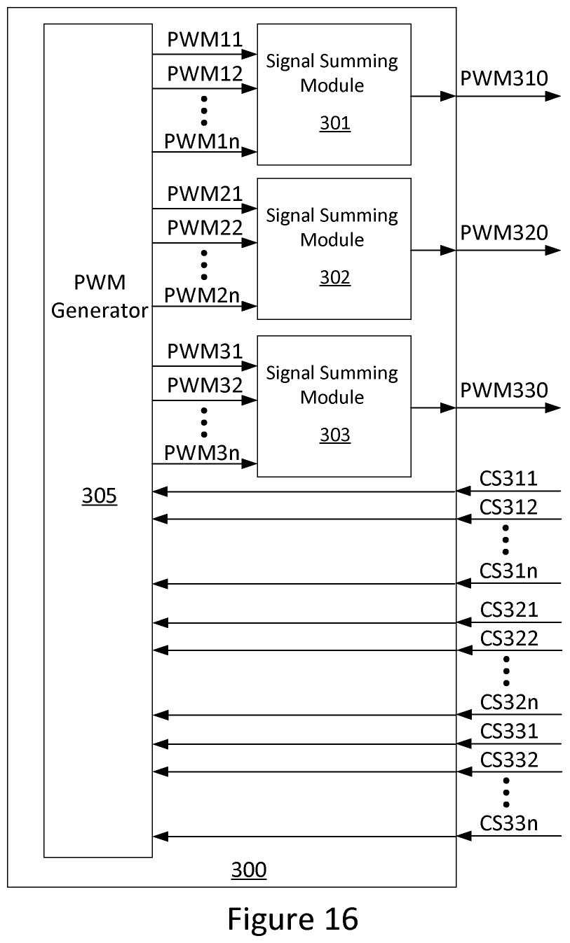

FIG. 15 illustrates a block diagram of a third implementation of a multiphase power conversion system having a reduced number of signal paths in accordance with various embodiments of the present disclosure. More specifically, the multiphase power conversion system comprises a multiphase controller 300 (which will be described in detail hereinafter with reference to FIG. 16) and a plurality of power stage modules (e.g., power stage module 1510, power stage module 1520, . . . , and power stage module 1530). Each of the plurality of power stage modules further comprises a phase splitter and a plurality of smart power stages. The smart power stage is implemented as a buck converter.

As shown in FIG. 15, specifically, the power stage module 1510 comprises a phase splitter 310 and a plurality of smart power stages 311, 312, . . . , and 31n. The smart power stage module 1520 comprises a phase splitter 320 and a plurality of smart power stages 321, 322, . . . , and 32n. The smart power stage module 1530 comprises a phase splitter 330 and a plurality of smart power stages 331, 332, . . . , and 33n.

Further, as shown in FIG. 15, the phase splitter 310 is configured to receive a mixed PWM signal PWM310 and split the mixed PWM signal PWM310 into a plurality of phase-shifted PWM signals PWM41, PWM42, . . . , and PWM4n. Likewise, the phase splitter 320 is configured to receive a mixed PWM signal PWM320 and split the mixed PWM signal PWM320 into a plurality of phase-shifted PWM signals PWM51, PWM52, . . . , and PWM5n. The phase splitter 330 is configured to receive a mixed PWM signal PWM330 and split the mixed PWM signal PWM330 into a plurality of phase-shifted PWM signals PWM61, PWM62, . . . , and PWM6n.

As shown in FIG. 15, each of the plurality of smart power stages in each power stage module is configured to receive each of the plurality of phase-shifted PWM signals respectively. Specifically, the smart power stages 311, 312, . . . , and 31n in power stage module 1510 are configured to receive each of the plurality of phase-shifted PWM signals PWM41, PWM42, . . . , and PWM4n respectively. Likewise, the smart power stages 321, 322, . . . , and 32n in power stage module 1520 are configured to receive each of the plurality of phase-shifted PWM signals PWM51, PWM52, . . . , and PWM5n respectively. The smart power stages 331, 332, . . . , and 33n in power stage module 1530 are configured to receive each of the plurality of phase-shifted PWM signals PWM61, PWM62, . . . , and PWM6n respectively.

As shown in FIG. 15, each of the plurality of smart power stages in each power stage module is configured to generate a current sense signal of the power stage module fed into the multiphase controller. More specifically, the smart power stage 311 is configured to generate a first current sense signal CS311 of the power stage module 1510 fed into the multiphase controller 300. The first current sense signal CS311 is proportional to a current flowing through an inductor L11 coupled to the smart power stage 311. The smart power stage 312 is configured to generate a second current sense signal CS312 of the power stage module 1510 fed into the multiphase controller 300. The second current sense signal CS312 is proportional to a current flowing through an inductor L12 coupled to the smart power stage 312. Likewise, the smart power stage 31n is configured to generate an n-th current sense signal CS31n of the power stage module 1510 fed into the multiphase controller 300. The n-th current sense signal CS31n is proportional to a current flowing through an inductor L1n coupled to the smart power stage 31n.

As shown in FIG. 15, the smart power stage 321 is configured to generate a first current sense signal CS321 of the power stage module 1520 fed into the multiphase controller 300. The first current sense signal CS321 is proportional to a current flowing through an inductor L21 coupled to the smart power stage 321. The smart power stage 322 is configured to generate a second current sense signal CS322 of the power stage module 1520 fed into the multiphase controller 300. The second current sense signal CS322 is proportional to a current flowing through an inductor L22 coupled to the smart power stage 322. Likewise, the smart power stage 32n is configured to generate an n-th current sense signal CS32n of the power stage module 1520 fed into the multiphase controller 300. The n-th current sense signal CS32n is proportional to a current flowing through an inductor L2n coupled to the smart power stage 32n.

As shown in FIG. 15, the smart power stage 331 is configured to generate a first current sense signal CS331 of the power stage module 1530 fed into the multiphase controller 300. The first current sense signal CS331 is proportional to a current flowing through an inductor L31 coupled to the smart power stage 331. The smart power stage 332 is configured to generate a second current sense signal CS332 of the power stage module 1530 fed into the multiphase controller 300. The second current sense signal CS332 is proportional to a current flowing through an inductor L32 coupled to the smart power stage 332. Likewise, the smart power stage 33n is configured to generate an n-th current sense signal CS33n of the power stage module 1530 fed into the multiphase controller 300. The n-th current sense signal CS33n is proportional to a current flowing through an inductor L3n coupled to the smart power stage 33n.

FIG. 16 illustrates a block diagram of the multiphase controller 300 shown in FIG. 15 in accordance with various embodiments of the present disclosure. The multiphase controller 300 further comprises a PWM generator 305 and a plurality of signal summing modules (e.g., signal summing module 301, 302 and 303). The PWM generator 305 is configured to generate multiple groups of PWM signals, each group of PWM signals comprising a plurality of PWM signals. For example, the PWM generator 305 is configured to generate a first group of PWM signals, a second group of PWM signals and a third group of PWM signals. The first group of PWM signals comprises PWM signals PWM11, PWM12, . . . , and PWM1n. The second group of PWM signals comprises PWM signals PWM21, PWM22, . . . , and PWM2n. The third group of PWM signals comprises PWM signals PWM31, PWM32, . . . , and PWM3n.

As shown in FIG. 16, each signal summing module is configured to receive each group of PWM signals respectively and combine the plurality of PWM signals in each group of PWM signals into a mixed PWM signal. More particularly, the first signal summing module 301 receives the first group of PWM signals PWM comprising PWM signals PWM11, PWM12, . . . , and PWM1n, and combines PWM signals PWM11, PWM12, . . . , and PWM1n into the mixed PWM signal PWM310. Likewise, the second signal summing module 302 receives the second group of PWM signals comprising PWM signals PWM21, PWM22, . . . , and PWM2n, and combines PWM signals PWM21, PWM22, . . . , and PWM2n into the mixed PWM signal PWM320. The third signal summing module 303 receives the third group of PWM signals PWM comprising PWM signals PWM31, PWM32, . . . , and PWM3n, and combines PWM signals PWM31, PWM32, . . . , and PWM3n into the mixed PWM signal PWM330.

As shown in FIG. 15, the number of PWM signal paths between the multiphase controller 300 and the plurality of the power stage modules 1510, 1520, . . . , 1530 is equal to the number of the plurality of the power stage modules 1510, 1520, . . . , 1530. The number of current sense signal paths between the multiphase controller 300 and the plurality of the power stage modules 1510, 1520, . . . , 1530 is equal to the number of the smart power stages in all power stage modules. The multiphase power conversion system as configured in FIG. 15 has a total of M smart power stages in all power stage modules 1510, 1520, . . . , 1530 and has n smart power stages in each of the power stage modules 1510, 1520, . . . , 1530. Therefore, the number of the plurality of the power stage modules 1510, 1520, . . . , 1530 is equal to M/n, which is also the number of PWM signal paths between the multiphase controller 300 and the plurality of the power stage modules 1510, 1520, . . . , 1530. The number of current sense signal paths between the multiphase controller 300 and the plurality of the power stage modules 1510, 1520, . . . , 1530 is equal to M, which is also the number of the smart power stages in all power stage modules. In total, there are (1+1/n)×M signal paths in FIG. 15.

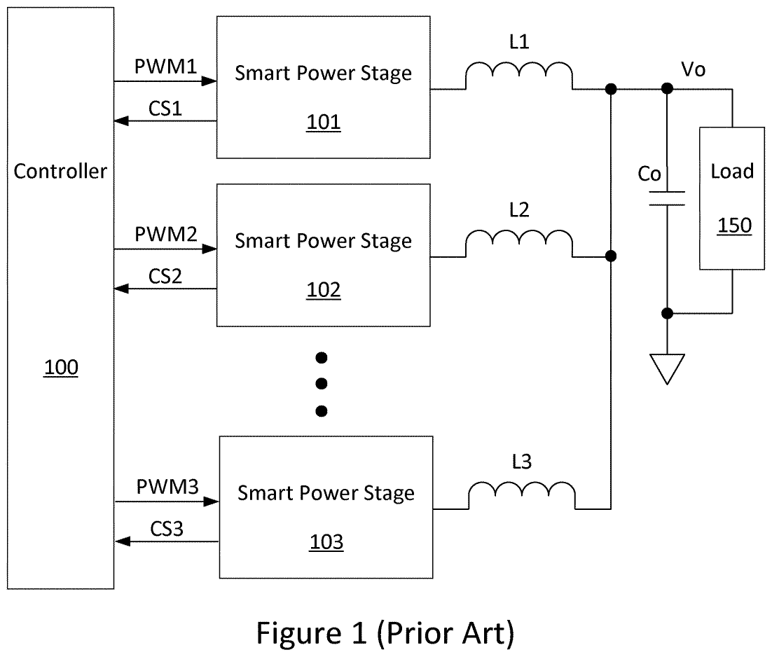

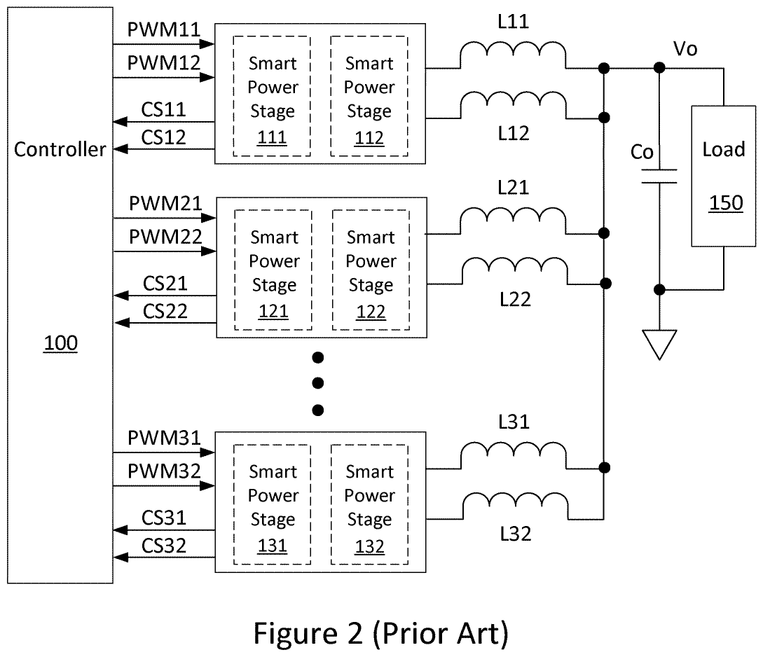

According to the traditional system configuration as shown in FIG. 1 or 2, the total number of signal paths between the multiphase controller and the power stage modules should be 2×M based on the number M of smart power stages in all power stage modules 1510, 1520, . . . , 1530. Compared with the traditional system configuration, one advantageous feature of the system configuration shown in FIG. 15 is that the total number of signal paths has been reduced from 2×M to (1+1/n)×M. The reduced number of signal paths helps to minimize layout issues and ensures better performance.

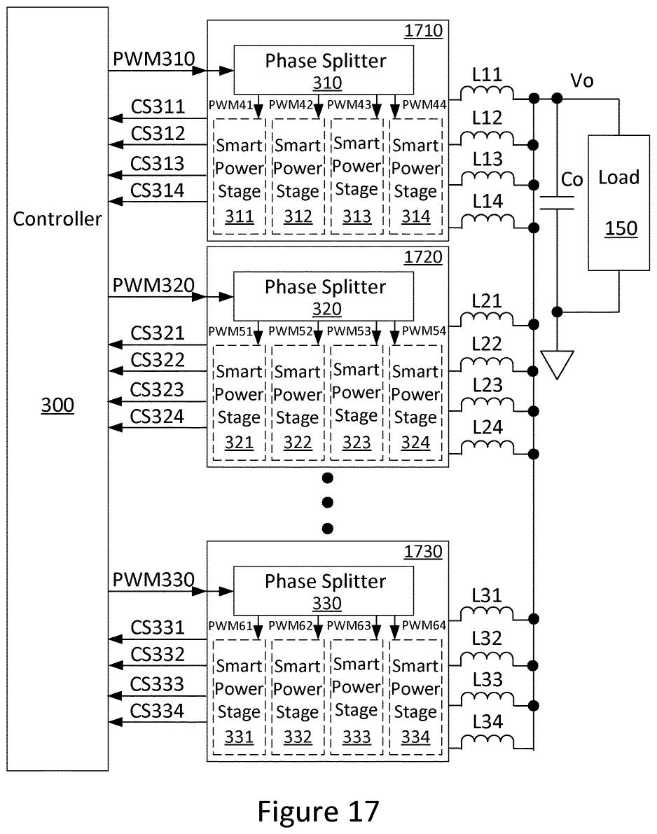

FIG. 17 illustrates a block diagram of a fourth implementation of a multiphase power conversion system having a reduced number of signal paths in accordance with various embodiments of the present disclosure. Specifically, the plurality of smart power stages in each of the plurality of power stage modules 1710, 1720, . . . , 1730 form a quad power stage, and the quad power stage further comprises a first power stage, a second power stage, a third power stage and a fourth power stage.

For example, the quad power stage in power stage module 1710 comprises a smart power stage 311, a smart power stage 312, a smart power stage 313 and a smart power stage 314. The smart power stage 311 is alternatively referred to as a first power stage of the power stage module 1710. The smart power stage 312 is alternatively referred to as a second power stage of the power stage module 1710. The smart power stage 313 is alternatively referred to as a third power stage of the power stage module 1710. The smart power stage 314 is alternatively referred to as a fourth power stage of the power stage module 1710.

The quad power stage in power stage module 1720 comprises a smart power stage 321, a smart power stage 322, a smart power stage 323 and a smart power stage 324. The smart power stage 321 is alternatively referred to as a first power stage of the power stage module 1720. The smart power stage 322 is alternatively referred to as a second power stage of the power stage module 1720. The smart power stage 323 is alternatively referred to as a third power stage of the power stage module 1720. The smart power stage 324 is alternatively referred to as a fourth power stage of the power stage module 1720.

The quad power stage in power stage module 1730 comprises a smart power stage 331, a smart power stage 332, a smart power stage 333 and a smart power stage 334. The smart power stage 331 is alternatively referred to as a first power stage of the power stage module 1730. The smart power stage 332 is alternatively referred to as a second power stage of the power stage module 1730. The smart power stage 333 is alternatively referred to as a third power stage of the power stage module 1730. The smart power stage 334 is alternatively referred to as a fourth power stage of the power stage module 1730.

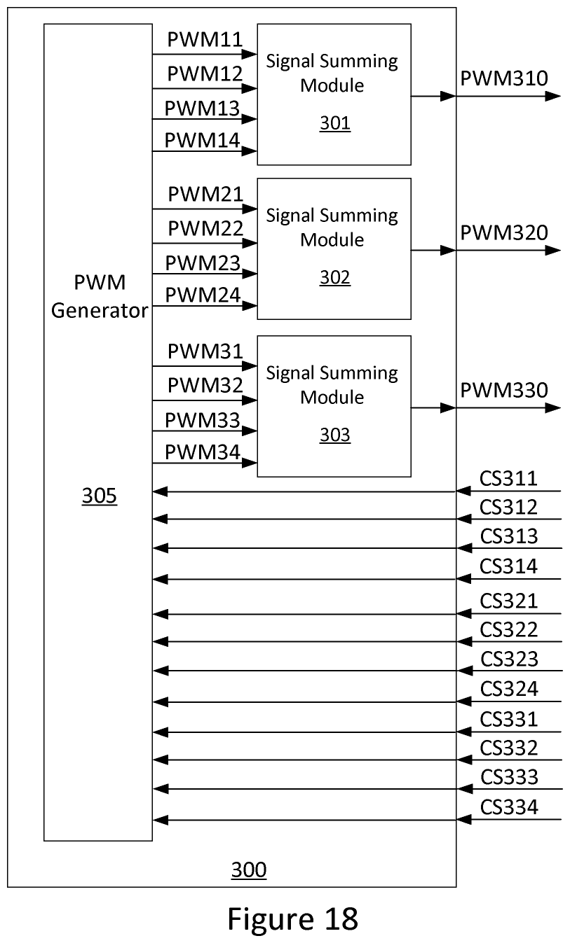

FIG. 18 illustrates a block diagram of the multiphase controller shown in FIG. 17 in accordance with various embodiments of the present disclosure. The multiphase controller 300 further comprises a PWM generator 305 and a plurality of signal summing modules (e.g., signal summing module 301, 302 and 303). The PWM generator 305 as shown in FIG. 18 is configured to generate multiple groups of PWM signals. For example, the PWM generator 305 is configured to generate a first group of PWM signals, a second group of PWM signals and a third group of PWM signals. The first group of PWM signals comprises a first PWM signal PWM11, a second PWM signal PWM12, a third PWM signal PWM13 and a fourth PWM signal PWM14. In some embodiments, a phase shift between adjacent ones of PWM11, PWM12, PWM13 and PWM14 is equal to 90 degrees. The second group of PWM signals comprises a first PWM signal PWM21, a second PWM signal PWM22, a third PWM signal PWM23 and a fourth PWM signal PWM24. In some embodiments, a phase shift between adjacent ones of PWM21, PWM22, PWM23 and PWM24 is equal to 90 degrees. The third group of PWM signals comprises a first PWM signal PWM31, a second PWM signal PWM32, a third PWM signal PWM33 and a fourth PWM signal PWM34. In some embodiments, a phase shift between adjacent ones of PWM31, PWM32, PWM33 and PWM34 is equal to 90 degrees. Further, the signal summing module 301 is configured to combine the first PWM signal PWM11, the second PWM signal PWM12, the third PWM signal PWM13 and the fourth PWM signal PWM14 into a mixed PWM signal PWM310. Likewise, the signal summing module 302 is configured to combine the first PWM signal PWM21, the second PWM signal PWM22, the third PWM signal PWM23 and the fourth PWM signal PWM24 into a mixed PWM signal PWM320. The signal summing module 303 is configured to combine the first PWM signal PWM31, the second PWM signal PWM32, the third PWM signal PWM33 and the fourth PWM signal PWM34 into a mixed PWM signal PWM330.

As shown in FIG. 17, the phase splitter 310 is configured to receive the mixed PWM signal 310 and split the mixed PWM signal 310 into a first phase-shifted PWM signal PWM41, a second phase-shifted PWM signal PWM42, a third phase-shifted PWM signal PWM43 and a fourth phase-shifted PWM signal PWM44. Likewise, the phase splitter 320 is configured to receive the mixed PWM signal 320 and split the mixed PWM signal 320 into a first phase-shifted PWM signal PWM51, a second phase-shifted PWM signal PWM52, a third phase-shifted PWM signal PWM53 and a fourth phase-shifted PWM signal PWM54. The phase splitter 330 is configured to receive the mixed PWM signal 330 and split the mixed PWM signal 330 into a first phase-shifted PWM signal PWM61, a second phase-shifted PWM signal PWM62, a third phase-shifted PWM signal PWM63 and a fourth phase-shifted PWM signal PWM64.

Further, as shown in FIG. 17, each of the first power stage, the second power stage, the third power stage and the fourth power stage is configured to receive a respective one of the first phase-shifted PWM signal, the second phase-shifted PWM signal, the third phase-shifted PWM signal and the fourth phase-shifted PWM signal. Specifically, in power stage module 1710, the first power stage 311 is configured to receive the first phase-shifted PWM signal PWM41, the second power stage 312 is configured to receive the second phase-shifted PWM signal PWM42, the third power stage 313 is configured to receive the third phase-shifted PWM signal PWM43, and the fourth power stage 314 is configured to receive the fourth phase-shifted PWM signal PWM44. In power stage module 1720, the first power stage 321 is configured to receive the first phase-shifted PWM signal PWM51, the second power stage 322 is configured to receive the second phase-shifted PWM signal PWM52, the third power stage 323 is configured to receive the third phase-shifted PWM signal PWM53, and the fourth power stage 324 is configured to receive the fourth phase-shifted PWM signal PWM54. In power stage module 1730, the first power stage 331 is configured to receive the first phase-shifted PWM signal PWM61, the second power stage 332 is configured to receive the second phase-shifted PWM signal PWM62, the third power stage 333 is configured to receive the third phase-shifted PWM signal PWM63, and the fourth power stage 334 is configured to receive the fourth phase-shifted PWM signal PWM64.

As shown in FIG. 17, the smart power stage 311 is configured to generate a first current sense signal CS311 of the power stage module 1710 fed into the multiphase controller 300. The first current sense signal CS311 is proportional to a current flowing through an inductor L11 coupled to the smart power stage 311. The smart power stage 312 is configured to generate a second current sense signal CS312 of the power stage module 1710 fed into the multiphase controller 300. The second current sense signal CS312 is proportional to a current flowing through an inductor L12 coupled to the smart power stage 312. The smart power stage 313 is configured to generate a third current sense signal CS313 of the power stage module 1710 fed into the multiphase controller 300. The third current sense signal CS313 is proportional to a current flowing through an inductor L13 coupled to the smart power stage 313. The smart power stage 314 is configured to generate a fourth current sense signal CS314 of the power stage module 1710 fed into the multiphase controller 300. The fourth current sense signal CS314 is proportional to a current flowing through an inductor L14 coupled to the smart power stage 314.

Further, the smart power stage 321 is configured to generate a first current sense signal CS321 of the power stage module 1720 fed into the multiphase controller 300. The first current sense signal CS321 is proportional to a current flowing through an inductor L21 coupled to the smart power stage 321. The smart power stage 322 is configured to generate a second current sense signal CS322 of the power stage module 1720 fed into the multiphase controller 300. The second current sense signal CS322 is proportional to a current flowing through an inductor L22 coupled to the smart power stage 322. The smart power stage 323 is configured to generate a third current sense signal CS323 of the power stage module 1720 fed into the multiphase controller 300. The third current sense signal CS323 is proportional to a current flowing through an inductor L23 coupled to the smart power stage 323. The smart power stage 324 is configured to generate a fourth current sense signal CS324 of the power stage module 1720 fed into the multiphase controller 300. The fourth current sense signal CS324 is proportional to a current flowing through an inductor L24 coupled to the smart power stage 324.

Further, the smart power stage 331 is configured to generate a first current sense signal CS331 of the power stage module 1730 fed into the multiphase controller 300. The first current sense signal CS331 is proportional to a current flowing through an inductor L31 coupled to the smart power stage 331. The smart power stage 332 is configured to generate a second current sense signal CS332 of the power stage module 1730 fed into the multiphase controller 300. The second current sense signal CS332 is proportional to a current flowing through an inductor L32 coupled to the smart power stage 332. The smart power stage 333 is configured to generate a third current sense signal CS333 of the power stage module 1730 fed into the multiphase controller 300. The third current sense signal CS333 is proportional to a current flowing through an inductor L33 coupled to the smart power stage 333. The smart power stage 334 is configured to generate a fourth current sense signal CS334 of the power stage module 1730 fed into the multiphase controller 300. The fourth current sense signal CS334 is proportional to a current flowing through an inductor L34 coupled to the smart power stage 334.

The multiphase power conversion system as configured in FIG. 17 has a total of M smart power stages in all power stage modules 1710, 1720, . . . , 1730 and has 4 smart power stages in each of the power stage modules 1710, 1720, . . . , 1730. Therefore, the number of the plurality of the power stage modules 1710, 1720, . . . , 1730 is equal to M/4, which is the number of PWM signal paths between the multiphase controller 300 and the plurality of the power stage modules 1710, 1720, . . . , 1730. The number of current sense signal paths between the multiphase controller 300 and the plurality of the power stage modules 1710, 1720, . . . , 1730 is equal to M, which is the number of the smart power stages in all power stage modules. In total, there are (5/4)×M signal paths in FIG. 17.

Compared with traditional system configuration, one advantageous feature of the system configuration shown in FIG. 17 is that the total number of signal paths has been reduced from 2×M to (5/4)×M. The reduced number of signal paths helps to minimize layout issues and ensures better performance.

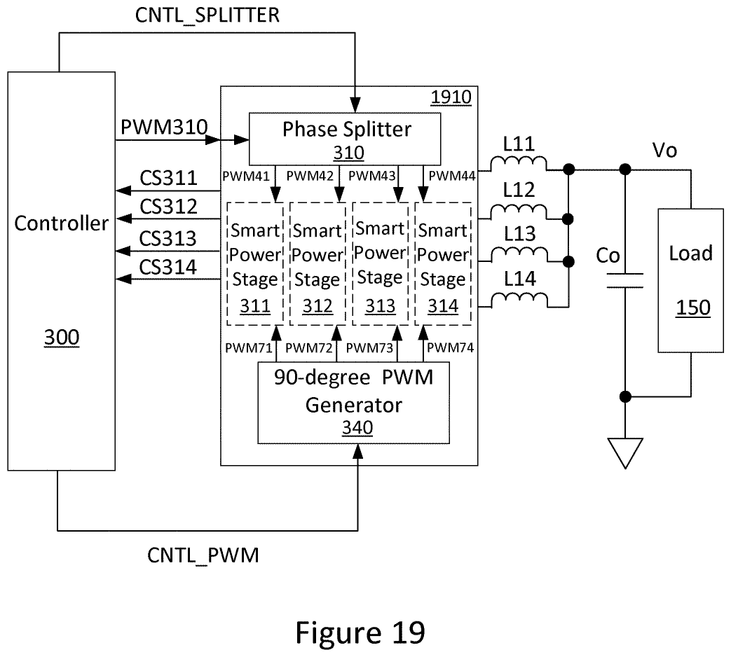

FIG. 19 illustrates a block diagram of a fifth implementation of a multiphase power conversion system having a reduced number of signal paths in accordance with various embodiments of the present disclosure.

As shown in FIG. 19, the power stage module 1910 further comprises a 90-degree PWM generator 340. FIG. 19 illustrates the configuration of the multiphase power conversion system with only power stage module 1910 as an example, the configurations of the other power stage modules are similar to that of power stage module 1910, hence are not illustrated and discussed herein to avoid repetition. The power conversion system as shown in FIG. 19 may be configured to operate in a first mode and a second mode. The detailed operation will be described hereinafter.

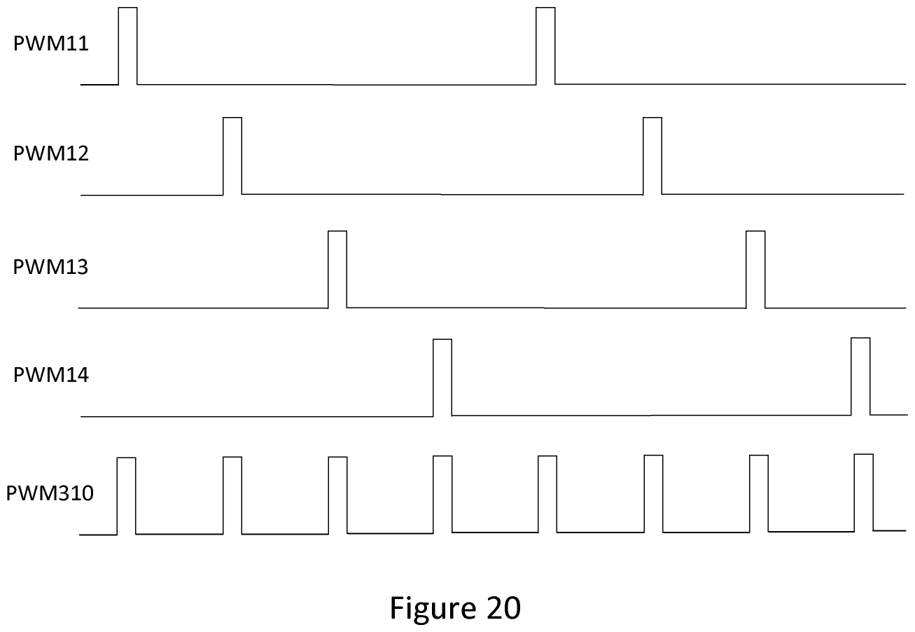

FIG. 20 illustrates various control signals associated with the signal summing module shown in FIG. 18 when the pulse width of PWM signals is less than 90 degrees in accordance with various embodiments of the present disclosure.

As shown in FIG. 20, in the operation of the first mode, when the pulse width of the first PWM signal PWM11, the second PWM signal PWM12, the third PWM signal PWM13 and the fourth PWM signal PWM14 is less than 90 degrees, the first PWM signal PWM11, the second PWM signal PWM12, the third PWM signal PWM13 and the fourth PWM signal PWM14 are combined by the signal summing module 301 into a mixed PWM signal PWM310.

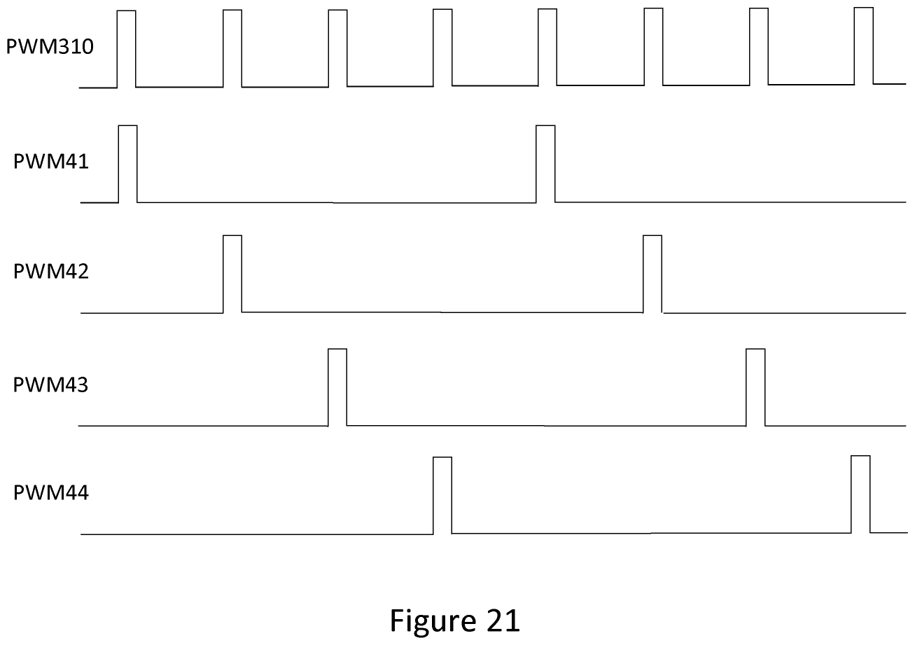

FIG. 21 illustrates various control signals associated with the phase splitter shown in FIG. 19 when the pulse width of PWM signals is less than 90 degrees in accordance with various embodiments of the present disclosure. Specifically, when the pulse width of PWM signals is less than 90 degrees, the phase splitter 310 is enabled to split the mixed PWM signal PWM310 shown in FIG. 20 into the first phase-shifted PWM signal PWM41, the second phase-shifted PWM signal PWM42, the third phase-shifted PWM signal PWM43 and the fourth phase-shifted PWM signal PWM44 which are respectively fed into a respective one of the first power stage 311, the second power stage 312, the third power stage 313 and the fourth power stage 314. As shown in FIG. 19, the phase splitter 310 can for example be enabled by a control signal CNTL_SPLITTER generated by the multiphase controller 300.

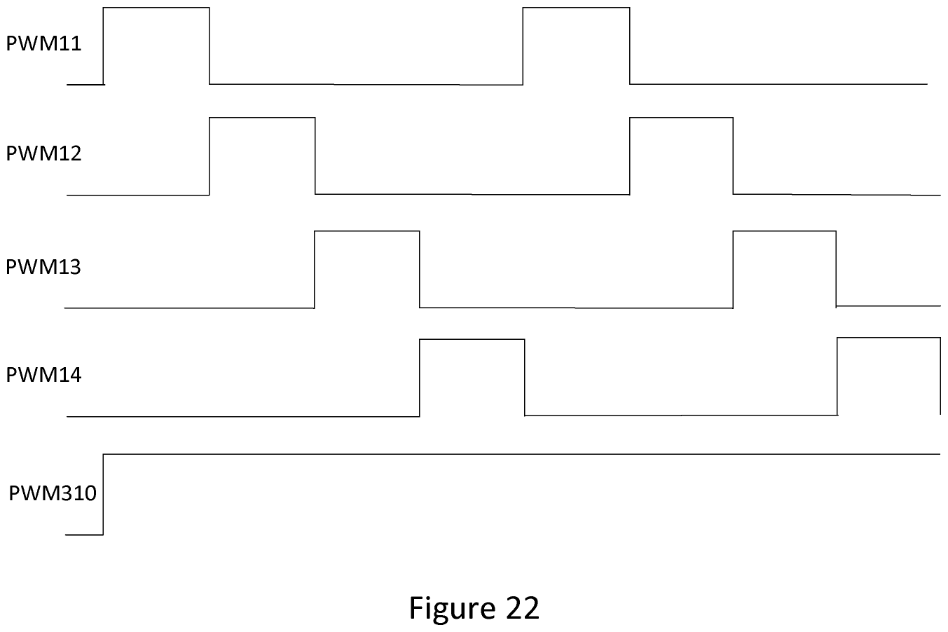

FIG. 22 illustrates various control signals associated with the signal summing module shown in FIG. 18 when the pulse width of PWM signals is equal to 90 degrees in accordance with various embodiments of the present disclosure. Specifically, when the pulse width of the first PWM signal PWM11, the second PWM signal PWM12, the third PWM signal PWM13 and the fourth PWM signal PWM14 is equal to 90 degrees, the rising edges and falling edges of the first PWM signal PWM11, the second PWM signal PWM12, the third PWM signal PWM13 and the fourth PWM signal PWM14 will touch with each other when combined by the signal summing module 301, thus will be combined into a mixed PWM signal PWM310, which forms a straight line as shown in FIG. 22.

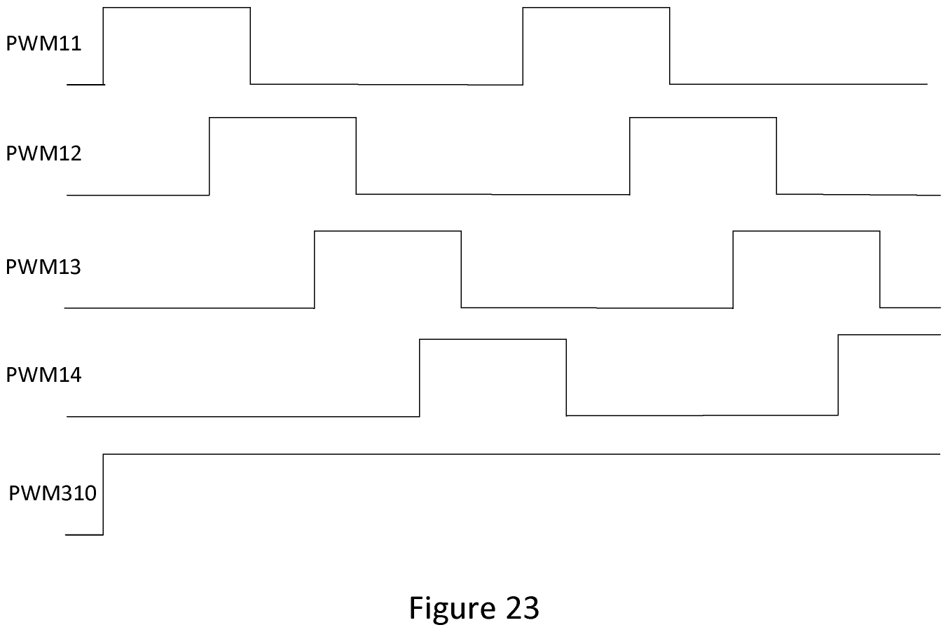

FIG. 23 illustrates various control signals associated with the signal summing module shown in FIG. 18 when the pulse width of PWM signals is greater than 90 degrees in accordance with various embodiments of the present disclosure. Specifically, when the pulse width of the first PWM signal PWM11, the second PWM signal PWM12, the third PWM signal PWM13 and the fourth PWM signal PWM14 is greater than 90 degrees, the rising edges and falling edges of the first PWM signal PWM11, the second PWM signal PWM12, the third PWM signal PWM13 and the fourth PWM signal PWM14 will overlap with each other when combined by the signal summing module 301, thus will be combined into a mixed PWM signal PWM310, which will also form a straight line as shown in FIG. 23.

Under the situations as shown in FIG. 22 or 23, when the pulse width of the first PWM signal PWM11, the second PWM signal PWM12, the third PWM signal PWM13 and the fourth PWM signal PWM14 is greater than or equal to 90 degrees and the mixed PWM signal PWM310 forms a straight line, the phase splitter 310 is not able to split the straight line of the mixed PWM signal PWM310 into a plurality of phase-shifted PWM signals. In this case, the power conversion system is configured to switch from the first mode to a second mode.

Specifically, upon switching to the second mode, the phase splitter 310 is disabled, which means the splitting process by the phase splitter 310 is disabled at the same time. However, the 90-degree PWM generator 340 provided in the power stage module 1910 shown in FIG. 19 is enabled to generate a first 90-degree PWM signal PWM71 fed to the first power stage 311, a second 90-degree PWM signal PWM72 fed to the second power stage 312, a third 90-degree PWM signal PWM73 fed to the third power stage 313 and a fourth 90-degree PWM signal PWM74 fed to the fourth power stage 314. As shown in FIG. 19, the phase splitter 310 can for example also be disabled by the control signal CNTL_SPLITTER generated by the multiphase controller 300, and the 90-degree PWM generator 340 can for example be enabled by a control signal CNTL_PWM generated by the multiphase controller 300.

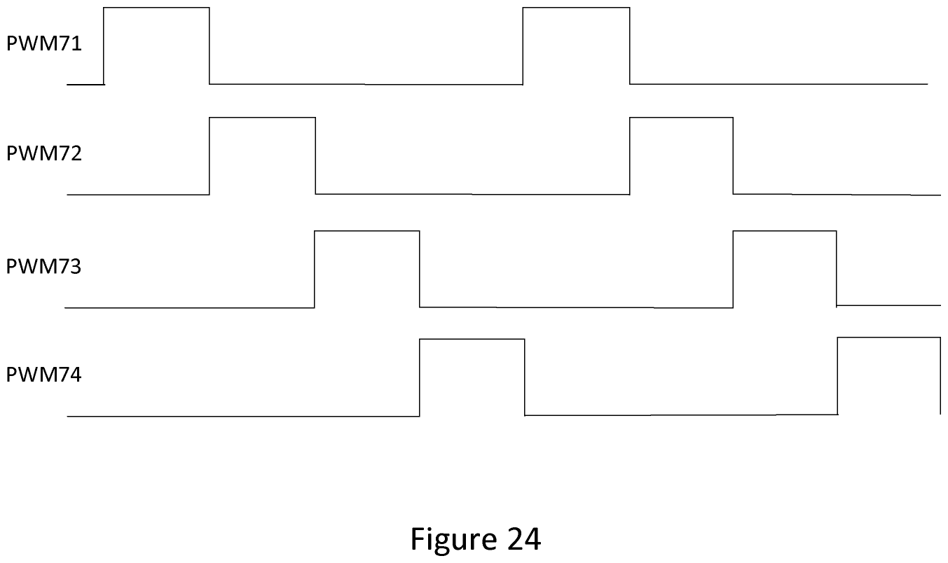

FIG. 24 illustrates the 90-degree PWM signals generated by the 90-degree PWM generator in accordance with an embodiment of the power conversion system of the present disclosure. Specifically, as FIG. 24 shows, the pulse width of the first 90-degree PWM signal PWM71, the second 90-degree PWM signal PWM72, the third 90-degree PWM signal PWM73 and the fourth 90-degree PWM signal PWM74 are all exactly 90 degrees.

One advantageous feature of the system configuration shown in FIG. 19 is that when the pulse widths of the first PWM signal PWM11, the second PWM signal PWM12, the third PWM signal PWM13 and the fourth PWM signal PWM14 are greater than or equal to 90 degrees and the mixed PWM signal PWM310 forms a straight line, the system configuration can provide 90-degree PWM signals to the smart power stages even when the phase splitter cannot split the straight line of mixed PWM signal into a plurality of phase-shifted PWM signals. The system configuration shown in FIG. 19 advantageously allows the system to fully utilize the available duty cycle during transient conditions, thereby improving transient response and enabling faster voltage recovery, for example, by delivering increased output power or current without being constrained by phase-splitting limitations. Accordingly, the system configuration shown in FIG. 19 provides enhanced flexibility, robustness, and performance under dynamic operating conditions.

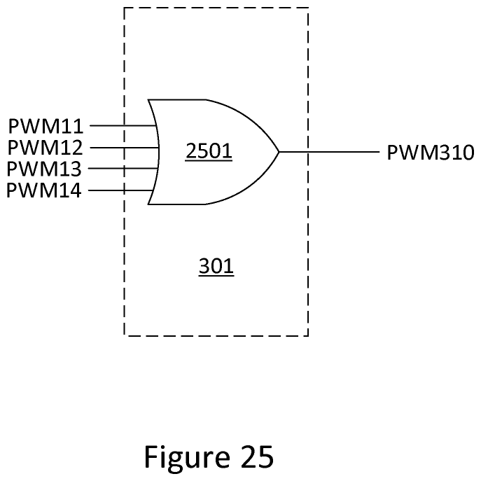

FIG. 25 illustrates a schematic diagram of a first implementation of the signal summing module shown in FIG. 18 in accordance with various embodiments of the present disclosure. Specifically, the signal summing module 301 comprises an OR gate 2501. A first input of the OR gate 2501 is configured to receive the first PWM signal PWM11. A second input of the OR gate 2501 is configured to receive the second PWM signal PWM12. A third input of the OR gate 2501 is configured to receive the third PWM signal PWM13. A fourth input of the OR gate 2501 is configured to receive the fourth PWM signal PWM14. An output of the OR gate 2501 is configured to generate the mixed PWM signal PWM310. The configurations of the other signal summing modules 302 and 303 are similar to that of signal summing module 301 according to a first implementation of the signal summing module, so will not be discussed herein in order to avoid repetition.

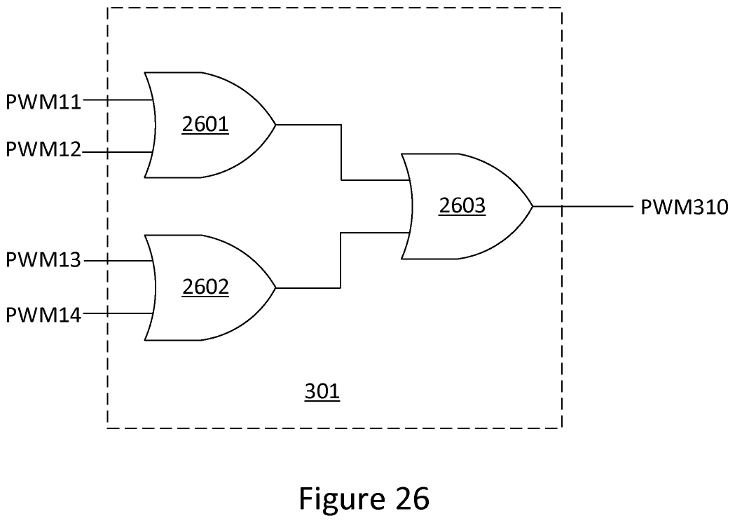

FIG. 26 illustrates a schematic diagram of a second implementation of the signal summing module shown in FIG. 18 in accordance with various embodiments of the present disclosure. Specifically, signal summing module 301 can alternatively comprise a first OR gate 2601, a second OR gate 2602, and a third OR gate 2603. A first input of the first OR gate 2601 is configured to receive the first PWM signal PWM11. A second input of the first OR gate 2601 is configured to receive the second PWM signal PWM12. A first input of the second OR gate 2602 is configured to receive the third PWM signal PWM13. A second input of the second OR gate 2602 is configured to receive the fourth PWM signal PWM14. A first input of the third OR gate 2603 is configured to be connected to an output of the first OR gate 2601. A second input of the third OR gate 2603 is configured to be connected to an output of the second OR gate 2602. An output of the third OR gate 2603 is configured to generate the mixed PWM signal PWM310. The configurations of the other signal summing modules 302 and 303 are similar to that of signal summing module 301 according to a second implementation of the signal summing module, so will not be discussed herein in order to avoid repetition.

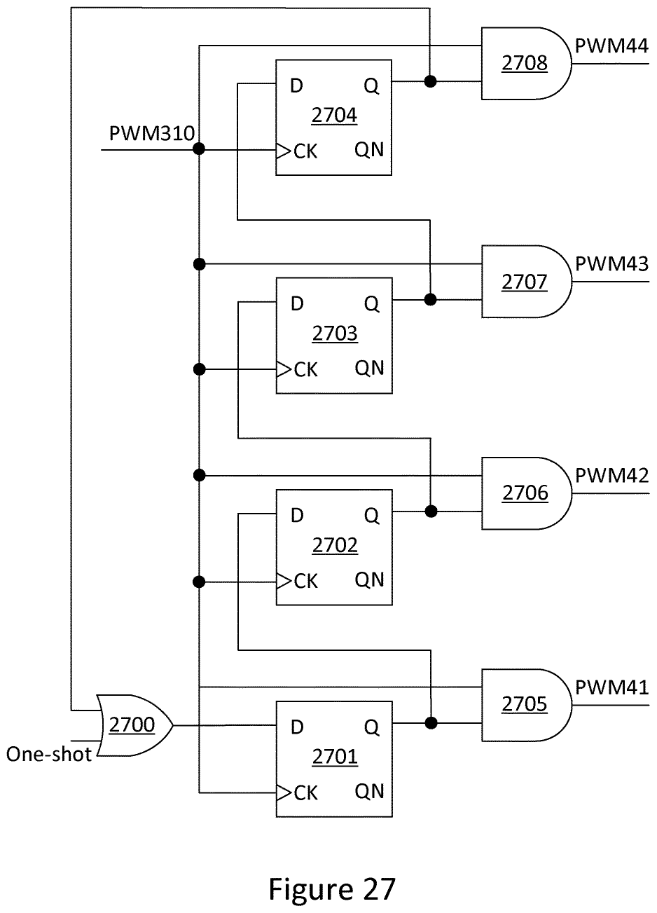

FIG. 27 illustrates a schematic diagram of the phase splitter shown in FIG. 17 when the pulse width of PWM signals is less than 90 degrees in accordance with various embodiments of the present disclosure. Specifically, the phase splitter 310 comprises an OR gate 2700, a first latch 2701, a second latch 2702, a third latch 2703, a fourth latch 2704, a first AND gate 2705, a second AND gate 2706, a third AND gate 2707, and a fourth AND gate 2708.

A first input of the OR gate 2700 is configured to receive a one-shot signal, the one-shot signal being configured to provide an initial logic high pulse to the first input of the OR gate 2700. A second input of the OR gate 2700 is connected to a non-inverted output of the fourth latch 2704. An output of the OR gate 2700 is connected to a data input of the first latch 2701. A non-inverted output of the first latch 2701 is connected to a data input of the second latch 2702. A non-inverted output of the second latch 2702 is connected to a data input of the third latch 2703. A non-inverted output of the third latch 2703 is connected to a data input of the fourth latch 2704.

A clock input of the first latch 2701, a clock input of the second latch 2702, a clock input of the third latch 2703, and a clock input of the fourth latch 2704 are configured to receive the mixed PWM signal PWM310. A first input of the first AND gate 2705, a first input of the second AND gate 2706, a first input of the third AND gate 2707 and a first input of the fourth AND gate 2708 are configured to receive the mixed PWM signal PWM310. A second input of the first AND gate 2705 is connected to the non-inverted output of the first latch 2701. A second input of the second AND gate 2706 is connected to the non-inverted output of the second latch 2702. A second input of the third AND gate 2707 is connected to the non-inverted output of the third latch 2703. A second input of the fourth AND gate 2708 is connected to the non-inverted output of the fourth latch 2704.

An output of the first AND gate 2705 is configured to generate the first phase-shifted PWM signal PWM41. An output of the second AND gate 2706 is configured to generate the second phase-shifted PWM signal PWM42. An output of the third AND gate 2707 is configured to generate the third phase-shifted PWM signal PWM43. An output of the fourth AND gate 2708 is configured to generate the fourth phase-shifted PWM signal PWM44.

The phase splitter shown in FIG. 27 is configured to split the mixed PWM signal PWM310 shown in FIG. 21 into the first phase-shifted PWM signal PWM41, the second phase-shifted PWM signal PWM42, the third phase-shifted PWM signal PWM43 and the fourth phase-shifted PWM signal PWM44, when the pulse width of the mixed PWM signal PWM310 is less than 90 degrees. The other phase splitters 320 and 330 shown in FIG. 17 have the similar configuration as that of the phase splitter 310, thus will not be discussed herein in order to avoid repetition.

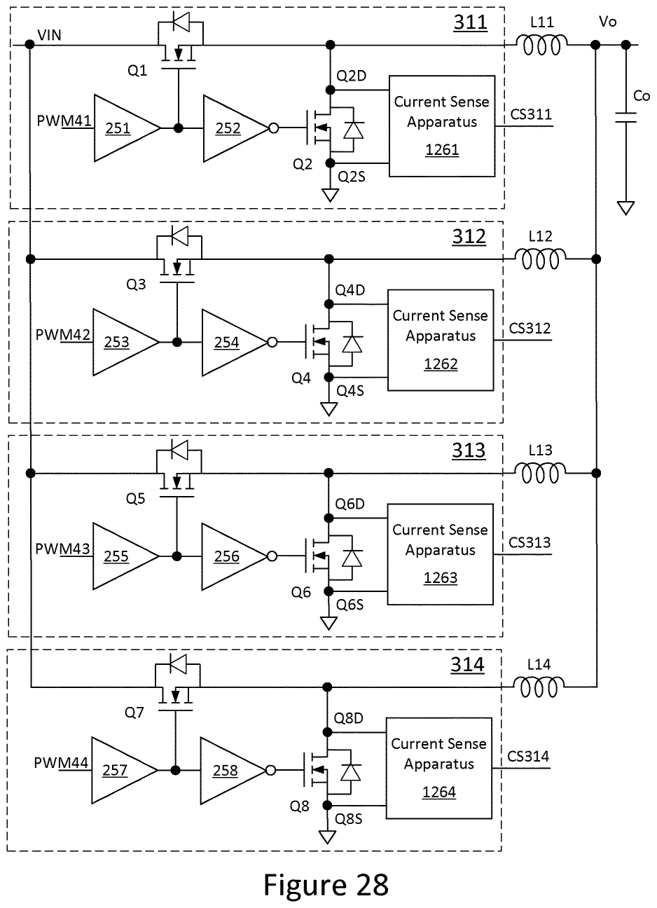

FIG. 28 illustrates a schematic diagram of a first implementation of the quad power stage shown in FIG. 17 in accordance with various embodiments of the present disclosure. The quad power stage comprises a first power stage 311, a second power stage 312, a third power stage 313 and a fourth power stage 314. As shown in FIG. 28, the first power stage 311 and the first inductor L11 form a first phase of the multiphase power conversion system. The second power stage 312 and the second inductor L12 form a second phase of the multiphase power conversion system. The third power stage 313 and the third inductor L13 form a third phase of the multiphase power conversion system. The fourth power stage 314 and the fourth inductor L14 form a fourth phase of the multiphase power conversion system. In operation, the first phase, the second phase, the third phase and the fourth phase are connected in parallel to supply power for a load coupled to the output voltage bus Vo of the multiphase power conversion system.

As shown in FIG. 28, the first phase of the multiphase power conversion system comprises a high-side switch Q1, a low-side switch Q2 and a first inductor L11. The high-side switch Q1 of the first phase and the first inductor L11 are connected in series between an input voltage bus VIN and the output voltage bus Vo. The low-side switch Q2 of the first phase is connected between a common node of the high-side switch Q1 of the first phase and the first inductor L11, and ground. An output capacitor Co is connected between the output voltage bus Vo and ground.

The second phase of the multiphase power conversion system comprises a high-side switch Q3, a low-side switch Q4 and the second inductor L12. The high-side switch Q3 of the second phase and the second inductor L12 are connected in series between the input voltage bus VIN and the output voltage bus Vo. The low-side switch Q4 of the second phase is connected between a common node of the high-side switch Q3 of the second phase and the second inductor L12, and ground.

The third phase of the multiphase power conversion system comprises a high-side switch Q5, a low-side switch Q6 and the third inductor L13. The high-side switch Q5 of the third phase and the third inductor L13 are connected in series between the input voltage bus VIN and the output voltage bus Vo. The low-side switch Q6 of the third phase is connected between a common node of the high-side switch Q5 of the third phase and the third inductor L13, and ground.

The fourth phase of the multiphase power conversion system comprises a high-side switch Q7, a low-side switch Q8 and the fourth inductor L14. The high-side switch Q7 of the fourth phase and the fourth inductor L14 are connected in series between the input voltage bus VIN and the output voltage bus Vo. The low-side switch Q8 of the fourth phase is connected between a common node of the high-side switch Q7 of the fourth phase and the fourth inductor L14, and ground.

The multiphase power conversion system further comprises a first current sense apparatus 1261, a second current sense apparatus 1262, a third current sense apparatus 1263, a fourth current sense apparatus 1264. As shown in FIG. 28, a first input of the first current sense apparatus 1261 is connected to a drain Q2D of the low-side switch Q2. A second input of the first current sense apparatus 1261 is connected to a source Q2S of the low-side switch Q2. The first current sense apparatus 1261 is configured to sense the current flowing through the first inductor L11. As shown in FIG. 28, the first current sense apparatus 1261 is configured to generate a first current sense signal CS311. The structure and operating principle of the first current sense apparatus 1261 are similar to the structure and operating principle of the current sense apparatus 262 shown in FIG. 8, and hence are not discussed herein to avoid repetition.

As shown in FIG. 28, a first input of the second current sense apparatus 1262 is connected to a drain Q4D of the low-side switch Q4. A second input of the second current sense apparatus 1262 is connected to a source Q4S of the low-side switch Q4. The second current sense apparatus 1262 is configured to sense the current flowing through the second inductor L12. As shown in FIG. 28, the second current sense apparatus 1262 is configured to generate a second current sense signal CS312. The structure and operating principle of the second current sense apparatus 1262 are similar to the structure and operating principle of the current sense apparatus 262 shown in FIG. 8, and hence are not discussed herein to avoid repetition.

As shown in FIG. 28, a first input of the third current sense apparatus 1263 is connected to a drain Q6D of the low-side switch Q6. A second input of the third current sense apparatus 1263 is connected to a source Q6S of the low-side switch Q6. The third current sense apparatus 1263 is configured to sense the current flowing through the third inductor L13. As shown in FIG. 28, the third current sense apparatus 1263 is configured to generate a third current sense signal CS313. The structure and operating principle of the third current sense apparatus 1263 are similar to the structure and operating principle of the current sense apparatus 262 shown in FIG. 8, and hence are not discussed herein to avoid repetition.

As shown in FIG. 28, a first input of the fourth current sense apparatus 1264 is connected to a drain Q8D of the low-side switch Q8. A second input of the fourth current sense apparatus 1264 is connected to a source Q8S of the low-side switch Q8. The fourth current sense apparatus 1264 is configured to sense the current flowing through the fourth inductor L14. As shown in FIG. 28, the fourth current sense apparatus 1264 is configured to generate a fourth current sense signal CS314. The structure and operating principle of the fourth current sense apparatus 1264 are similar to the structure and operating principle of the current sense apparatus 262 shown in FIG. 8, and hence are not discussed herein to avoid repetition.

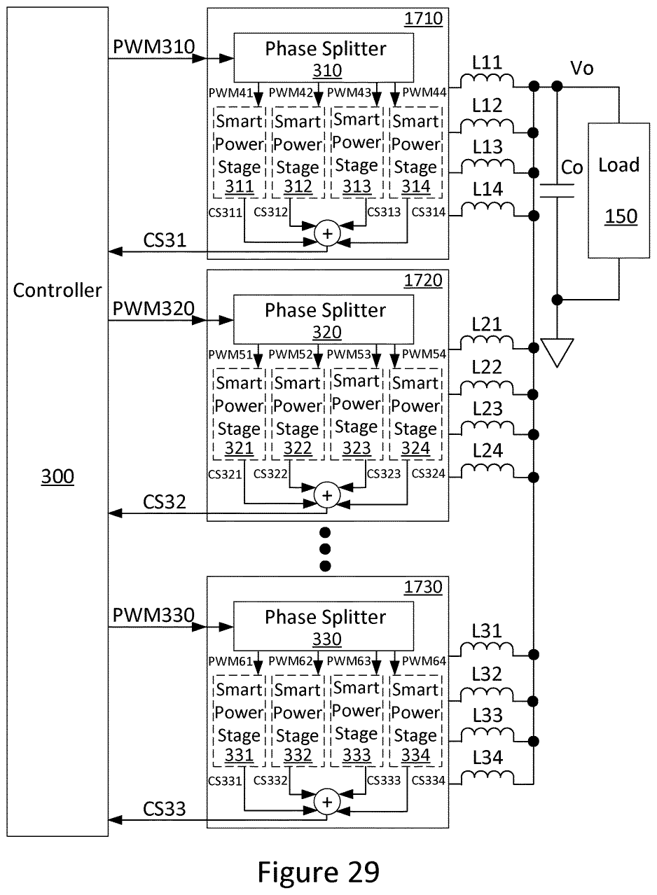

FIG. 29 illustrates a block diagram of a sixth implementation of a multiphase power conversion system having a reduced number of signal paths in accordance with various embodiments of the present disclosure. The system configuration shown in FIG. 29 is similar to that shown in FIG. 17 except that each of the plurality of quad power stage comprises a current summing module.

As shown in FIG. 29, the smart power stage 311 is configured to generate a first current sense signal CS311 fed into a first input of a current summing module of the power stage module 1710. The smart power stage 312 is configured to generate a second current sense signal CS312 fed into a second input of the current summing module of the power stage module 1710. The smart power stage 313 is configured to generate a third current sense signal CS313 fed into a third input of the current summing module of the power stage module 1710. The smart power stage 314 is configured to generate a fourth current sense signal CS314 fed into a fourth input of the current summing module of the power stage module 1710. The current summing module is configured to sum the first current sense signal CS311, the second current sense signal CS312, the third current sense signal CS313 and the fourth current sense signal CS314 together to obtain a mixed current sense signal CS31 fed into the multiphase controller 300.

As shown in FIG. 29, the smart power stage 321 is configured to generate a first current sense signal CS321 fed into a first input of a current summing module of the power stage module 1720. The smart power stage 322 is configured to generate a second current sense signal CS322 fed into a second input of the current summing module of the power stage module 1720. The smart power stage 323 is configured to generate a third current sense signal CS323 fed into a third input of the current summing module of the power stage module 1720. The smart power stage 324 is configured to generate a fourth current sense signal CS324 fed into a fourth input of the current summing module of the power stage module 1720. The current summing module is configured to sum the first current sense signal CS321, the second current sense signal CS322, the third current sense signal CS323 and the fourth current sense signal CS324 together to obtain a mixed current sense signal CS32 fed into the multiphase controller 300.

The smart power stage 331 is configured to generate a first current sense signal CS331 fed into a first input of a current summing module of the power stage module 1730. The smart power stage 332 is configured to generate a second current sense signal CS332 fed into a second input of the current summing module of the power stage module 1730. The smart power stage 333 is configured to generate a third current sense signal CS333 fed into a third input of the current summing module of the power stage module 1730. The smart power stage 334 is configured to generate a fourth current sense signal CS334 fed into a fourth input of the current summing module of the power stage module 1730. The current summing module is configured to sum the first current sense signal CS331, the second current sense signal CS332, the third current sense signal CS333 and the fourth current sense signal CS334 together to obtain a mixed current sense signal CS33 fed into the multiphase controller 300.

As shown in FIG. 29, the number of PWM signal paths between the multiphase controller 300 and the plurality of power stage modules is equal to the number of the plurality of power stage modules. The number of current sense signal paths between the multiphase controller 300 and the plurality of power stage modules is equal to the number of the plurality of power stage modules. FIG. 29 shows for a multiphase power conversion system having M smart power stages in all power stage modules, the number of PWM signal paths is equal to M/N. N is the number of the power stage modules. The number of current sense signal paths is equal to M/N. In total, there are (2×M)/N signal paths in FIG. 29.

One advantageous feature of the system configuration shown in FIG. 29 is that the total number of signal paths has been reduced (from 2×M to (2×M)/N). The reduced number of signal paths helps to minimize layout issues and ensures better performance.

Corresponding to the configuration of the power conversion system as shown in FIG. 17, the present disclosure also discloses a method comprising: combining a plurality of PWM signals into a mixed PWM signal PWM310 fed into a power stage module 1710, the plurality of PWM signals comprises a first PWM signal PWM11, a second PWM signal PWM12, a third PWM signal PWM13 and a fourth PWM signal PWM14, and the power stage module 1710 comprises a first power stage 311, a second power stage 312, a third power stage 313 and a fourth power stage 314; splitting the mixed PWM signal PWM310 into a first phase-shifted PWM signal PWM41 fed into the first power stage 311, a second phase-shifted PWM signal PWM42 fed into the second power stage 312, a third phase-shifted PWM signal PWM43 fed into the third power stage 313 and a fourth phase-shifted PWM signal PWM44 fed into the fourth power stage 314; generating a first current sense signal CS311, a second current sense signal CS312, a third current sense signal CS313 and a fourth current sense signal CS314, wherein the first current sense signal CS311 is proportional to a current flowing through a first inductor L11 coupled to the first power stage 311, the second current sense signal CS312 is proportional to a current flowing through a second inductor L12 coupled to the second power stage 312, the third current sense signal CS313 is proportional to a current flowing through a third inductor L13 coupled to the third power stage 313 and the fourth current sense signal CS314 is proportional to a current flowing through a fourth inductor L14 coupled to the fourth power stage 314; and summing the first current sense signal CS311, the second current sense signal CS312, the third current sense signal CS313 and the fourth current sense signal CS314 together to obtain a mixed current sense signal fed into a PWM generator configured to generate the plurality of PWM signals.

Further, the method comprises: when the pulse width of the first PWM signal PWM11, the second PWM signal PWM12, the third PWM signal PWM13 and the fourth PWM signal PWM14 is less than 90 degrees, enabling the step of splitting the mixed PWM signal PWM310 into the first phase-shifted PWM signal PWM41, the second phase-shifted PWM signal PWM42, the third phase-shifted PWM signal PWM43 and the fourth phase-shifted PWM signal PWM44; and when the pulse width of the first PWM signal, the second PWM signal, the third PWM signal and the fourth PWM signal is greater than or equal to 90 degrees, disabling the step of splitting and enabling a 90-degree PWM generator to generate a first 90-degree PWM signal, a second 90-degree PWM signal, a third 90-degree PWM signal and a fourth 90-degree PWM signal, each of which having a pulse width of 90 degrees and being fed to a respective one of the first power stage, the second power stage, the third power stage, and the fourth power stage.

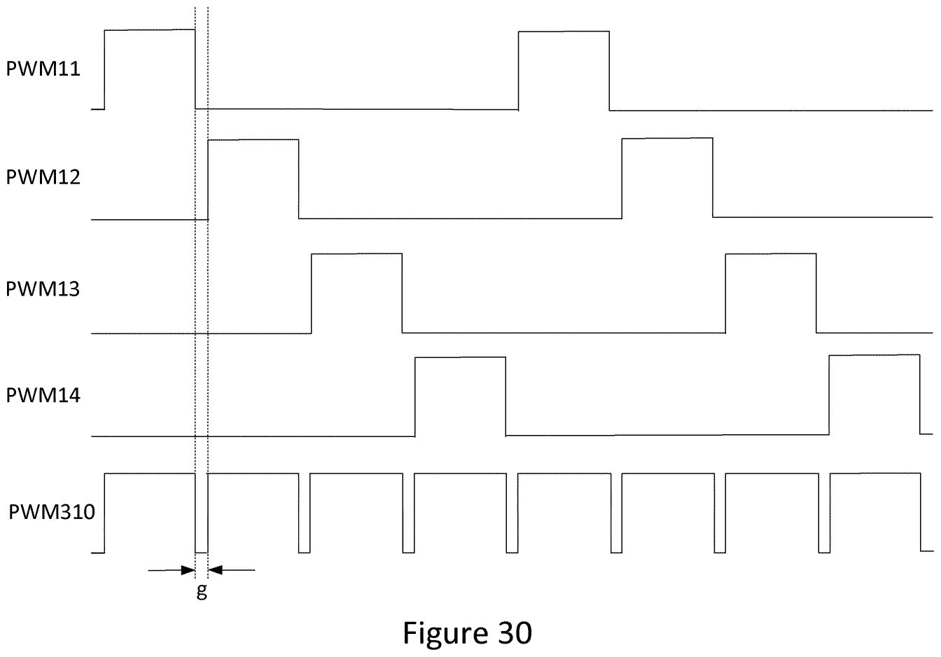

FIG. 30 illustrates waveforms of the PWM signals with a high duty cycle in accordance with various embodiments of the present disclosure. Compared with the waveforms of the PWM signals shown in FIG. 20 where the first PWM signal PWM11, the second PWM signal PWM12, the third PWM signal PWM13 and the fourth PWM signal PWM14 have a narrow pulse width and the mixed PWM signal PWM310 has a low duty cycle, FIG. 30 illustrates a situation when the first PWM signal PWM11, the second PWM signal PWM12, the third PWM signal PWM13 and the fourth PWM signal PWM14 have a wide pulse width, thus the mixed PWM signal PWM310 has a high duty cycle, which means the gap g among the pulses of the mixed PWM signal PWM310 is narrow. Although the mixed PWM signal PWM310 with narrow gaps as shown in FIG. 30 can be split into phase-shifted PWM signals by the phase splitter, the too narrow gaps among the pulses of the mixed PWM signal might cause the phase splitting function of the phase splitter to break down or to be stressed in practice.

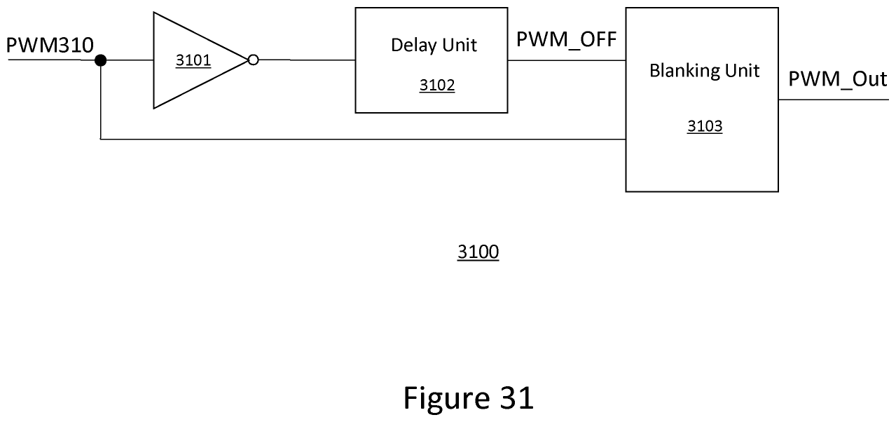

FIG. 31 illustrates a block diagram of a PWM processing unit in accordance with various embodiments of the present disclosure. Specifically, the power stage modules 1710, 1720 and 1730 of the power conversion system of the present disclosure as shown in FIG. 17 may further comprise a PWM processing unit 3100 which is configured to widen the gaps among the pulses of the mixed PWM signal PWM310 before the mixed PWM signal PWM310 is fed into the phase splitter. FIG. 30 only illustrates the PWM signals PWM11, PWM12, PWM13 and PWM14 and the mixed PWM signal PWM310 related to the power stage module 1710 as an example, the configurations of other power stage modules 1720 and 1730 are similar to that of power stage module 1710, thus will not be discussed in order to avoid repetition.

The PWM processing unit 3100 operates as follows. The PWM processing unit 3100 is configured to process the mixed PWM signal PWM310 and to enforce a minimum off-time between successive output pulses. The PWM processing unit 3100 includes an inverter 3101, a delay unit 3102, and a blanking unit 3103.

During operation, the mixed PWM signal PWM310 is provided to both a control path and a signal path. In the control path, the mixed PWM signal PWM310 is coupled to an inverter 3101, which generates an inverted signal. The inverted signal is provided to a delay unit 3102, which generates a control signal PWM_OFF corresponding to a predetermined delay interval.

When the mixed PWM signal PWM310 transitions from a logic HIGH state to a logic LOW state, the inverter 3101 produces a corresponding rising edge from a logic LOW state to a logic HIGH state. Delay unit 3102 delays the rising edge to generate the control signal PWM_OFF such that the control signal PWM_OFF remains in a logic LOW state for a duration corresponding to the delay interval and transitions to a logic HIGH state after expiration of the delay interval.

The blanking unit 3103 receives the mixed PWM signal PWM310 and the control signal PWM_OFF and is configured to selectively inhibit propagation of the mixed PWM signal PWM310 based on the state of the control signal PWM_OFF. While the control signal PWM_OFF remains in the logic LOW state, the blanking unit 3103 blocks the mixed PWM signal PWM310 such that an output PWM signal PWM_Out is maintained in a logic LOW state.

When the control signal PWM_OFF transitions to the logic HIGH state, the blanking unit 3103 ceases blanking and permits an output PWM signal PWM_Out to follow the instantaneous logic state of the mixed PWM signal PWM310. Accordingly, the PWM pulses occurring during the delay interval are suppressed, thereby ensuring that a minimum off-time is maintained between successive output pulses. After the processing by the PWM processing unit 3100, the output PWM signal PWM_Out is fed into the phase splitter.

The delay unit 3102 can typically be implemented by a timing capacitor charged by a constant current source, or an RC delay structure. The voltage across the timing capacitor increases. A comparator monitors the voltage across the timing capacitor. When the voltage reaches a predefined threshold, the minimum off-time interval is considered satisfied.

In accordance with an embodiment, a power conversion system comprises a multiphase controller comprising a PWM generator and a plurality of signal summing modules, wherein the PWM generator is configured to generate multiple groups of PWM signals, each group of PWM signals comprising a plurality of PWM signals, and each signal summing module is configured to receive each group of PWM signals respectively and combine the plurality of PWM signals in each group of PWM signals into a mixed PWM signal, and a plurality of power stage modules, each of the plurality of power stage modules comprising a phase splitter and a plurality of power stages, wherein the phase splitter is configured to receive the mixed PWM signal and split the mixed PWM signal into a plurality of phase-shifted PWM signals, and each of the plurality of power stages is configured to receive each of the plurality of phase-shifted PWM signals respectively.

In accordance with another embodiment, a method comprises combining a plurality of PWM signals into a mixed PWM signal fed into a power stage module, wherein, the plurality of PWM signals comprises a first PWM signal, a second PWM signal, a third PWM signal and a fourth PWM signal, and the power stage module comprises a first power stage, a second power stage, a third power stage and a fourth power stage, splitting the mixed PWM signal into a first phase-shifted PWM signal fed into the first power stage, a second phase-shifted PWM signal fed into the second power stage, a third phase-shifted PWM signal fed into the third power stage and a fourth phase-shifted PWM signal fed into the fourth power stage, generating a first current sense signal, a second current sense signal, a third current sense signal and a fourth current sense signal, wherein the first current sense signal is proportional to a current flowing through a first inductor coupled to the first power stage, the second current sense signal is proportional to a current flowing through a second inductor coupled to the second power stage, the third current sense signal is proportional to a current flowing through a third inductor coupled to the third power stage, and the fourth current sense signal is proportional to a current flowing through a fourth inductor coupled to the fourth power stage, and summing the first current sense signal, the second current sense signal, the third current sense signal and the fourth current sense signal together to obtain a mixed current sense signal fed into a PWM generator configured to generate the plurality of PWM signals.

In accordance with yet another embodiment, a system comprises a multiphase controller comprising a PWM generator and a plurality of signal summing modules, wherein the PWM generator is configured to generate multiple groups of PWM signals, each group of PWM signals comprising a plurality of PWM signals, and each signal summing module is configured to receive each group of PWM signals respectively and combine the plurality of PWM signals in each group of PWM signals into a mixed PWM signal, a plurality of power stage modules, each of the plurality of power stage modules comprising a phase splitter and a plurality of power stages, wherein the phase splitter is configured to receive the mixed PWM signal and split the mixed PWM signal into a plurality of phase-shifted PWM signals, and each of the plurality of power stages is configured to receive each of the plurality of phase-shifted PWM signals respectively; and a plurality of inductors, each of the plurality of inductors being coupled between each of the plurality of power stages and an output of the system.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. A power conversion system comprising:
a multiphase controller comprising a PWM generator and a plurality of signal summing modules, wherein the PWM generator is configured to generate multiple groups of PWM signals, each group of PWM signals comprising a plurality of PWM signals, and each signal summing module is configured to receive each group of PWM signals respectively and combine the plurality of PWM signals in each group of PWM signals into a mixed PWM signal; and
a plurality of power stage modules, each of the plurality of power stage modules comprising a phase splitter and a plurality of power stages, wherein the phase splitter is configured to receive the mixed PWM signal and split the mixed PWM signal into a plurality of phase-shifted PWM signals, and each of the plurality of power stages is configured to receive each of the plurality of phase-shifted PWM signals respectively.

2. The power conversion system of claim 1, wherein:
the plurality of power stages in each of the plurality of power stage modules form a quad power stage, the quad power stage comprising a first power stage, a second power stage, a third power stage and a fourth power stage,
each group of PWM signals comprises a first PWM signal, a second PWM signal, a third PWM signal and a fourth PWM signal, and each signal summing module is configured to combine the first PWM signal, the second PWM signal, the third PWM signal and the fourth PWM signal into the mixed PWM signal, and
the phase splitter is configured to receive the mixed PWM signal and split the mixed PWM signal into a first phase-shifted PWM signal, a second phase-shifted PWM signal, a third phase-shifted PWM signal and a fourth phase-shifted PWM signal, and each of the first power stage, the second power stage, the third power stage and the fourth power stage is configured to receive a respective one of the first phase-shifted PWM signal, the second phase-shifted PWM signal, the third phase-shifted PWM signal and the fourth phase-shifted PWM signal.

3. The power conversion system of claim 2, wherein each of the plurality of power stage modules further comprises a 90-degree PWM generator, and the power conversion system is configured to operate in a first mode and a second mode, wherein:
in the first mode, when the pulse width of the first PWM signal, the second PWM signal, the third PWM signal and the fourth PWM signal is less than 90 degrees, the phase splitter is enabled to split the mixed PWM signal into the first phase-shifted PWM signal, the second phase-shifted PWM signal, the third phase-shifted PWM signal and the fourth phase-shifted PWM signal which are respectively fed into a respective one of the first power stage, the second power stage, the third power stage and the fourth power stage; and
in the second mode, when the pulse widths of the first PWM signal, the second PWM signal, the third PWM signal and the fourth PWM signal are greater than or equal to 90 degrees, the phase splitter is disabled and the 90-degree PWM generator is enabled to generate a first 90-degree PWM signal, a second 90-degree PWM signal, a third 90-degree PWM signal and a fourth 90-degree PWM signal, each of which having a pulse width of 90 degrees and being fed to a respective one of the first power stage, the second power stage, the third power stage, and the fourth power stage.

4. The power conversion system of claim 3, wherein:
the phase splitter is enabled and disabled in response to a first control signal generated from the multiphase controller; and
the 90-degree PWM generator is enabled in response to a second control signal generated from the multiphase controller.

5. The power conversion system of claim 2, wherein:
each signal summing module comprises an OR gate, and wherein:
a first input of the OR gate is configured to receive the first PWM signal;
a second input of the OR gate is configured to receive the second PWM signal;
a third input of the OR gate is configured to receive the third PWM signal;
a fourth input of the OR gate is configured to receive the fourth PWM signal; and
an output of the OR gate is configured to generate the mixed PWM signal.

6. The power conversion system of claim 2, wherein:
each signal summing module comprises a first OR gate, a second OR gate, and a third OR gate, and wherein:
a first input of the first OR gate is configured to receive the first PWM signal;
a second input of the first OR gate is configured to receive the second PWM signal;
a first input of the second OR gate is configured to receive the third PWM signal;
a second input of the second OR gate is configured to receive the fourth PWM signal;
a first input of the third OR gate is configured to receive an output signal of the first OR gate;
a second input of the third OR gate is configured to receive an output signal of the second OR gate; and
an output of the third OR gate is configured to generate the mixed PWM signal.

7. The power conversion system of claim 2, wherein:
the phase splitter comprises an OR gate, a first latch, a second latch, a third latch, a fourth latch, a first AND gate, a second AND gate, a third AND gate, and a fourth AND gate, and wherein:
a first input of the OR gate is configured to receive a one-shot signal, wherein the one-shot signal is configured to provide an initial logic high pulse to the first input of the OR gate;
a second input of the OR gate is connected to a non-inverted output of the fourth latch;
an output of the OR gate is connected to a data input of the first latch;
a non-inverted output of the first latch is connected to a data input of the second latch;
a non-inverted output of the second latch is connected to a data input of the third latch;
a non-inverted output of the third latch is connected to a data input of the fourth latch;
a clock input of the first latch, a clock input of the second latch, a clock input of the third latch, and a clock input of the fourth latch are configured to receive the mixed PWM signal;
a first input of the first AND gate, a first input of the second AND gate, a first input of the third AND gate and a first input of the fourth AND gate are configured to receive the mixed PWM signal;
a second input of the first AND gate is connected to the non-inverted output of the first latch;
a second input of the second AND gate is connected to the non-inverted output of the second latch;
a second input of the third AND gate is connected to the non-inverted output of the third latch; and
a second input of the fourth AND gate is connected to the non-inverted output of the fourth latch;
an output of the first AND gate is configured to generate the first phase-shifted PWM signal;
an output of the second AND gate is configured to generate the second phase-shifted PWM signal;
an output of the third AND gate is configured to generate the third phase-shifted PWM signal; and
an output of the fourth AND gate is configured to generate the fourth phase-shifted PWM signal.

8. The power conversion system of claim 2, wherein:
the first power stage is configured to generate a first current sense signal, and wherein the first current sense signal is proportional to a current flowing through a first inductor coupled to the first power stage;
the second power stage is configured to generate a second current sense signal, and wherein the second current sense signal is proportional to a current flowing through a second inductor coupled to the second power stage;
the third power stage is configured to generate a third current sense signal, and wherein the third current sense signal is proportional to a current flowing through a third inductor coupled to the third power stage; and
the fourth power stage is configured to generate a fourth current sense signal, and wherein the fourth current sense signal is proportional to a current flowing through a fourth inductor coupled to the fourth power stage.

9. The power conversion system of claim 8, further comprising:
a current summing module, wherein:
the first current sense signal is fed into a first input of the current summing module;
the second current sense signal is fed into a second input of the current summing module;
the third current sense signal is fed into a third input of the current summing module; and
the fourth current sense signal is fed into a fourth input of the current summing module, and wherein the current summing module is configured to sum the first current sense signal, the second current sense signal, the third current sense signal and the fourth current sense signal together to obtain a mixed current sense signal fed into the PWM generator.

10. The power conversion system of claim 9, wherein:
as a result of having the current summing module, a number of current sense signal paths in the power conversion system is equal to one fourth of the number of the plurality of power stages in the power conversion system.

11. The power conversion system of claim 8, wherein:
the first power stage and the first inductor form a first phase of the power conversion system, and wherein the first power stage comprises:
a high-side switch of the first power stage connected between an input voltage bus and the first inductor;
a low-side switch of the first power stage connected between a common node of the high-side switch of the first power stage and the first inductor, and ground; and
a first current sense apparatus having two inputs coupled to two terminals of the low-side switch of the first power stage, respectively, and an output configured to generate the first current sense signal;
the second power stage and the second inductor form a second phase of the power conversion system, and wherein the second power stage comprises:
a high-side switch of the second power stage connected between the input voltage bus and the second inductor;
a low-side switch of the second power stage connected between a common node of the high-side switch of the second power stage and the second inductor, and ground; and
a second current sense apparatus having two inputs coupled to two terminals of the low-side switch of the second power stage, respectively, and an output configured to generate the second current sense signal;
the third power stage and the third inductor form a third phase of the power conversion system, and wherein the third power stage comprises:
a high-side switch of the third power stage connected between the input voltage bus and the third inductor;
a low-side switch of the third power stage connected between a common node of the high-side switch of the third power stage and the third inductor, and ground; and
a third current sense apparatus having two inputs coupled to two terminals of the low-side switch of the third power stage, respectively, and an output configured to generate the third current sense signal; and
the fourth power stage and the fourth inductor form a fourth phase of the power conversion system, and wherein the fourth power stage comprises:
a high-side switch of the fourth power stage connected between the input voltage bus and the fourth inductor;
a low-side switch of the fourth power stage connected between a common node of the high-side switch of the fourth power stage and the fourth inductor, and ground; and
a fourth current sense apparatus having two inputs coupled to two terminals of the low-side switch of the fourth power stage, respectively, and an output configured to generate the fourth current sense signal.

12. The power conversion system of claim 11, wherein:
the first current sense apparatus comprises a first phase PWM off time current sense circuit, a first phase PWM on time current rebuild circuit and a first phase feedback loop;
the first phase PWM off time current sense circuit is configured to generate a first phase PWM off time current signal proportional to a current flowing through the first inductor in the first phase when the high-side switch of the first phase is turned off and the low-side switch of the first phase is turned on;
the first phase PWM on time current rebuild circuit is configured to construct an artificial first phase inductor current signal using a first phase voltage-controlled current source to charge a first rebuild capacitor when the high-side switch of the first phase is turned on; and
the first phase feedback loop is configured to adjust a current flowing through the first phase voltage-controlled current source so as to force a saved voltage of the artificial first phase inductor current signal to be equal to a saved voltage of the first phase PWM off time current signal.

13. The power conversion system of claim 2, wherein:
a phase shift between adjacent ones of the first, second, third, and fourth PWM signals is equal to 90 degrees.

14. A method comprising:
combining a plurality of PWM signals into a mixed PWM signal fed into a power stage module, wherein, the plurality of PWM signals comprises a first PWM signal, a second PWM signal, a third PWM signal and a fourth PWM signal, and the power stage module comprises a first power stage, a second power stage, a third power stage and a fourth power stage;
splitting the mixed PWM signal into a first phase-shifted PWM signal fed into the first power stage, a second phase-shifted PWM signal fed into the second power stage, a third phase-shifted PWM signal fed into the third power stage and a fourth phase-shifted PWM signal fed into the fourth power stage;
generating a first current sense signal, a second current sense signal, a third current sense signal and a fourth current sense signal, wherein the first current sense signal is proportional to a current flowing through a first inductor coupled to the first power stage, the second current sense signal is proportional to a current flowing through a second inductor coupled to the second power stage, the third current sense signal is proportional to a current flowing through a third inductor coupled to the third power stage, and the fourth current sense signal is proportional to a current flowing through a fourth inductor coupled to the fourth power stage; and
summing the first current sense signal, the second current sense signal, the third current sense signal and the fourth current sense signal together to obtain a mixed current sense signal fed into a PWM generator configured to generate the plurality of PWM signals.

15. The method of claim 14, further comprising:
enabling the step of splitting the mixed PWM signal into the first phase-shifted PWM signal, the second phase-shifted PWM signal, the third phase-shifted PWM signal and the fourth phase-shifted PWM signal when the pulse widths of the first PWM signal, the second PWM signal, the third PWM signal and the fourth PWM signal are less than 90 degrees; and
disabling the step of splitting, and enabling a 90-degree PWM generator to generate a first 90-degree PWM signal, a second 90-degree PWM signal, a third 90-degree PWM signal and a fourth 90-degree PWM signal, each of which having a pulse width of 90 degrees and being fed to a respective one of the first power stage, the second power stage, the third power stage, and the fourth power stage when the pulse widths of the first PWM signal, the second PWM signal, the third PWM signal and the fourth PWM signal are greater than or equal to 90 degrees.

16. The method of claim 14, wherein:
the step of splitting is enabled and disabled in response to a first control signal generated from a multiphase controller, and a 90-degree PWM generator is enabled in response to a second control signal generated from the multiphase controller.

17. A system comprising:
a multiphase controller comprising a PWM generator and a plurality of signal summing modules, wherein the PWM generator is configured to generate multiple groups of PWM signals, each group of PWM signals comprising a plurality of PWM signals, and each signal summing module is configured to receive each group of PWM signals respectively and combine the plurality of PWM signals in each group of PWM signals into a mixed PWM signal;
a plurality of power stage modules, each of the plurality of power stage modules comprising a phase splitter and a plurality of power stages, wherein the phase splitter is configured to receive the mixed PWM signal and split the mixed PWM signal into a plurality of phase-shifted PWM signals, and each of the plurality of power stages is configured to receive each of the plurality of phase-shifted PWM signals respectively; and
a plurality of inductors, each of the plurality of inductors being coupled between each of the plurality of power stages and an output of the system.

18. The system of claim 17, wherein the plurality of power stages in each of the plurality of power stage modules form a quad power stage, the quad power stage comprising a first power stage, a second power stage, a third power stage and a fourth power stage, and wherein:
each group of PWM signals comprises a first PWM signal, a second PWM signal, a third PWM signal and a fourth PWM signal, and each signal summing module is configured to combine the first PWM signal, the second PWM signal, the third PWM signal and the fourth PWM signal into the mixed PWM signal; and
the phase splitter is configured to receive the mixed PWM signal and split the mixed PWM signal into a first phase-shifted PWM signal, a second phase-shifted PWM signal, a third phase-shifted PWM signal and a fourth phase-shifted PWM signal, and each of the first power stage, the second power stage, the third power stage and the fourth power stage is configured to receive a respective one of the first phase-shifted PWM signal, the second phase-shifted PWM signal, the third phase-shifted PWM signal and the fourth phase-shifted PWM signal.

19. The system of claim 18, wherein each of the plurality of power stage modules further comprises a 90-degree PWM generator, and the system is configured to operate in a first mode and a second mode, and wherein:
in the first mode, when the pulse widths of the first PWM signal, the second PWM signal, the third PWM signal and the fourth PWM signal are less than 90 degrees, the phase splitter is enabled to split the mixed PWM signal into the first phase-shifted PWM signal, the second phase-shifted PWM signal, the third phase-shifted PWM signal and the fourth phase-shifted PWM signal which are respectively fed into a respective one of the first power stage, the second power stage, the third power stage and the fourth power stage; and
in the second mode, when the pulse widths of the first PWM signal, the second PWM signal, the third PWM signal and the fourth PWM signal are greater than or equal to 90 degrees, the phase splitter is disabled and the 90-degree PWM generator is enabled to generate a first 90-degree PWM signal, a second 90-degree PWM signal, a third 90-degree PWM signal and a fourth 90-degree PWM signal, each of which having a pulse width of 90 degrees and being fed to a respective one of the first power stage, the second power stage, the third power stage, and the fourth power stage.

20. The system of claim 18, further comprising:
a current summing module, wherein:
a first current sense signal is fed into a first input of the current summing module;
a second current sense signal is fed into a second input of the current summing module;
a third current sense signal is fed into a third input of the current summing module; and
a fourth current sense signal is fed into a fourth input of the current summing module, and wherein the current summing module is configured to sum the first current sense signal, the second current sense signal, the third current sense signal and the fourth current sense signal together to obtain a mixed current sense signal fed into the PWM generator.
